(19) United States
(12) Patent Application Publication
(10) Pub. No.: US 2025/0258817 A1
(43) Pub. Date: Aug. 14, 2025

(54) Convolution and Cross-Correlation of Count Sketches Enables Fast Cardinality Estimation of Multi-Join Queries

(71) Applicant: The Regents of The University of California, Oakland, CA (US)

(72) Inventors: Mike Heddes, Irvine, CA (US); Igor de Oliveira Nunes, Irvine, CA (US); Tony D. Givargis, Irvine, CA (US); Alexandru Nicolau, Irvine, CA (US)

(73) Assignee: The Regents of The University of California, Oakland, CA (US)

(21) Appl. No.: 19/045,825

(22) Filed: Feb. 5, 2025

Related U.S. Application Data
(60) Provisional application No. 63/551,308, filed on Feb. 8, 2024.

(51) Int. Cl. G06F 16/2453

(52) U.S. Cl. CPC G06F 16/24537

(57) ABSTRACT

Systems and methods to estimate cardinality of multi-join queries are disclosed. The method includes determining sign values and bin indices for joined attributes of a particular relation using corresponding sign functions and bin functions initialized for the joined attributes of a particular relation. The method includes combining the determined sign values to obtain a combined determined sign value and combining the determined bin indices to obtain a combined determined bin index for a particular tuple in the particular relation stream. The method includes creating a tuple sketch based on the combined determined sign value and the combined determined bin index. The method includes creating relation sketches for corresponding relations. The relation sketch is created by accumulating, on a relation basis, tuple sketches of corresponding tuples in the particular relation stream. The method includes, combining, at inference, the relation sketches to estimate a cardinality of the multi-join query.

### PRIORITY APPLICATION

This application claims the benefit of U.S. Patent Application No. 63/551,308, entitled “CONVOLUTION AND CROSS-CORRELATION OF COUNT SKETCHES ENABLES FAST CARDINALITY ESTIMATION OF MULTI-JOIN QUERIES,” filed on Feb. 8, 2024 (Attorney Docket No. UCI1002USP01). The provisional patent application is incorporated by reference for all purposes.

### FIELD OF THE TECHNOLOGY DISCLOSED

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. In particular, the technology disclosed relates to efficient cardinality estimation of multi-join queries across relations in a database.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### DESCRIPTION OF RELATED ART

Critical systems are generating data large amounts of data at ever increasing rates, making it difficult to estimate cardinality of multi-join queries across relations in a database. Existing techniques to estimate cardinality of multi-join queries emphasize on different aspects of cardinality estimation. For example, AMS sketch was originally developed to estimate the second frequency moment of a data stream. Since then, other techniques have been proposed for cardinality estimation. However, combining the strengths of these methods to maintain sketches for multi-join queries while ensuring fast update times is a non-trivial task.

It is desirable to provide systems and methods that can address deficiencies of existing cardinality estimation technique by providing fast updates to sketches of relations for cardinality estimation.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1A presents a high-level architecture of a system to estimate cardinality of multi-join queries.

FIG. 1B presents an example of creating sketches of relations using the technology disclosed.

FIG. 1C presents examples of estimating cardinality for multi-join queries across relations in a database.

FIG. 1D presents a process flowchart comprising operations to create sketches of relations for estimating cardinality for multi-join queries.

FIG. 2 presents a table illustrating notation that is used to describe the systems and methods disclosed herein.

FIG. 3 presents an example comparison of two sketching techniques performing a sketch update of an item in the stream.

FIG. 4 presents an example join graph for multiple relations and corresponding multi-join query.

FIG. 5 presents an example illustrating comparison of Hadamard product and circular convolution on two single item Count Sketches.

FIG. 6 presents a high-level process presenting process steps (or operations) to estimate cardinality of a multi-join query using the technology disclosed.

FIG. 7 presents an example method to create sketches of relations.

FIG. 8 presents an example method to estimate cardinality of multi-join queries.

FIG. 9 presents a graphical illustration of estimation process for example query presented in FIG. 4 with attribute 4 selected as the root node.

FIG. 10 presents a table illustrating time complexity of each estimation stage comparing the technology disclosed with other estimation techniques.

FIG. 11 presents a graphical illustration of total number of entries across all columns of both STATS and IMDB databases.

FIG. 12 presents a table illustrating database size statistics.

FIG. 13 presents percentage of all relations among all queries by their number of joins and the percentage of queries by their relation with the maximum number of joins.

FIGS. 14A, 14B, 14C, 14D and 14E present comparison of errors when using the technology disclosed with errors when using other cardinality estimation techniques.

FIG. 15 presents a graphical illustration of kernel density estimates of the power law exponents from the absolute relative error plots for two hundred and sixteen (216) queries.

FIG. 16 presents a table illustrating throughput in tuples processed per second using the technology disclosed in comparison with other techniques.

FIGS. 17A, 17B and 17C present execution times of the three stages (initialization, sketching/training and inference) of the baseline technology and the technology disclosed at varying sketch/model sizes.

FIG. 18 presents a graph illustrating cumulative distribution function of the q-error.

FIG. 19 presents PostgreSQL plan execution time and percentage improvement using different cardinality estimators.

FIG. 20 presents a computer system that can be used to implement the cardinality estimation technology disclosed herein.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### INTRODUCTION

With the increasing rate of data generated by critical systems, estimating functions on streaming data has become essential. This demand has driven numerous advancements in algorithms designed to efficiently query and analyze one or more data streams while operating under memory constraints. The primary challenge arises from the rapid influx of new items, requiring algorithms that enable efficient incremental processing of streams in order to keep up. A prominent algorithm in this domain is the AMS sketch. Originally developed to estimate the second frequency moment of a data stream, it can also estimate the cardinality of the equi-join between two relations. Since then, two important advancements are the Count sketch, a method which significantly improves upon the sketch update time, and secondly, an extension of the AMS sketch to accommodate multi-join queries. However, combining the strengths of these methods to maintain sketches for multi-join queries while ensuring fast update times is a non-trivial task, and has remained an open problem for decades as highlighted in the existing literature. The technology disclosed successfully addresses this problem by introducing a novel sketching method which has fast updates, even for sketches capable of accurately estimating the cardinality of complex multi-join queries. We prove that our estimator is unbiased and has the same error guarantees as the AMS-based method. Our experimental results confirm the significant improvement in update time complexity, resulting in orders of magnitude faster estimates, with equal or better estimation accuracy.

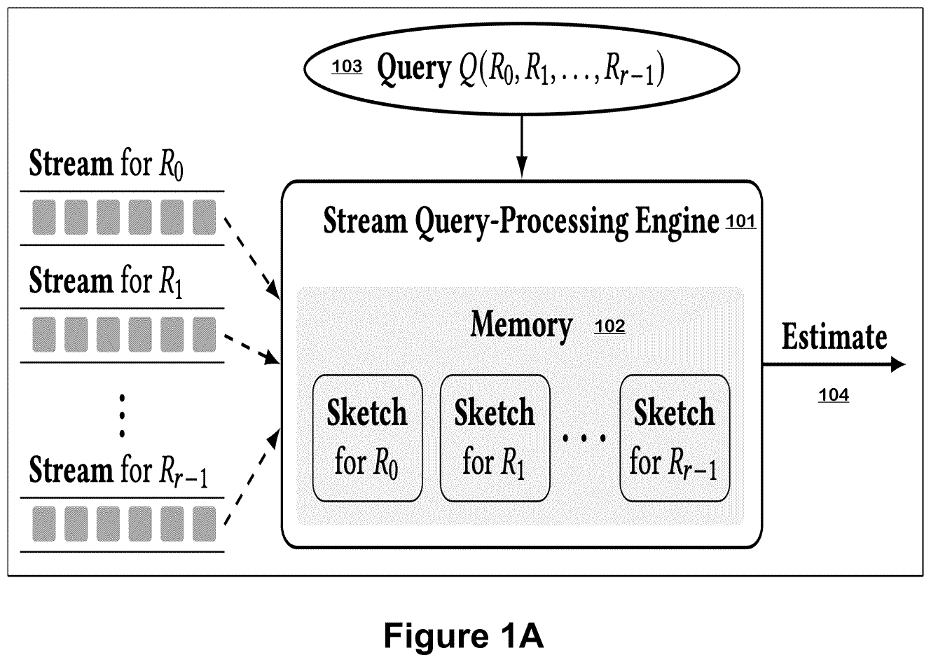

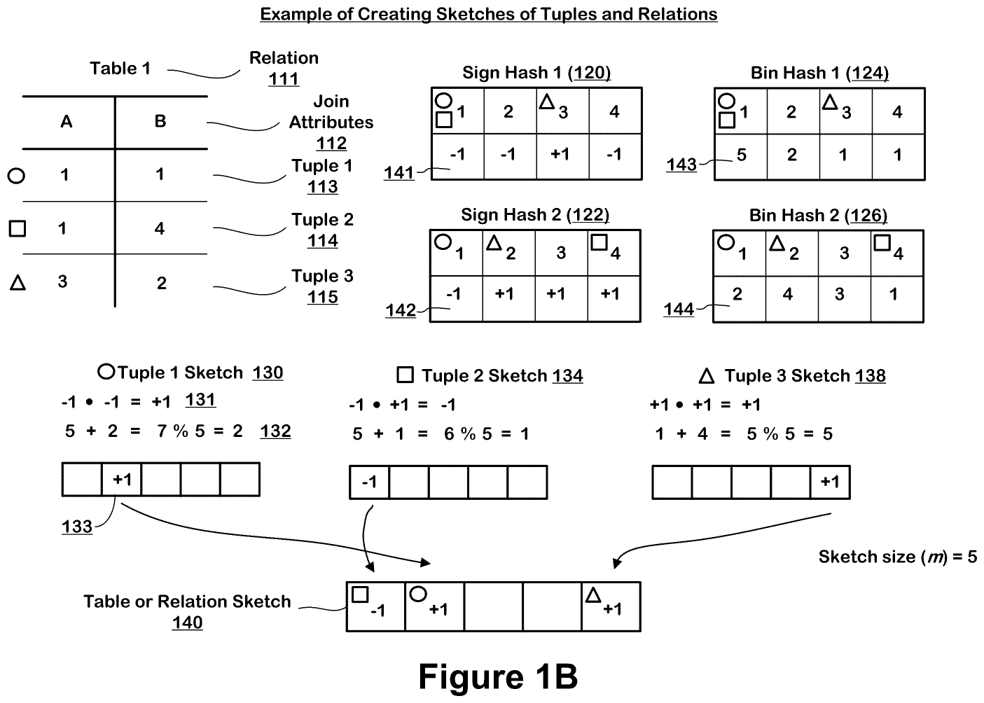

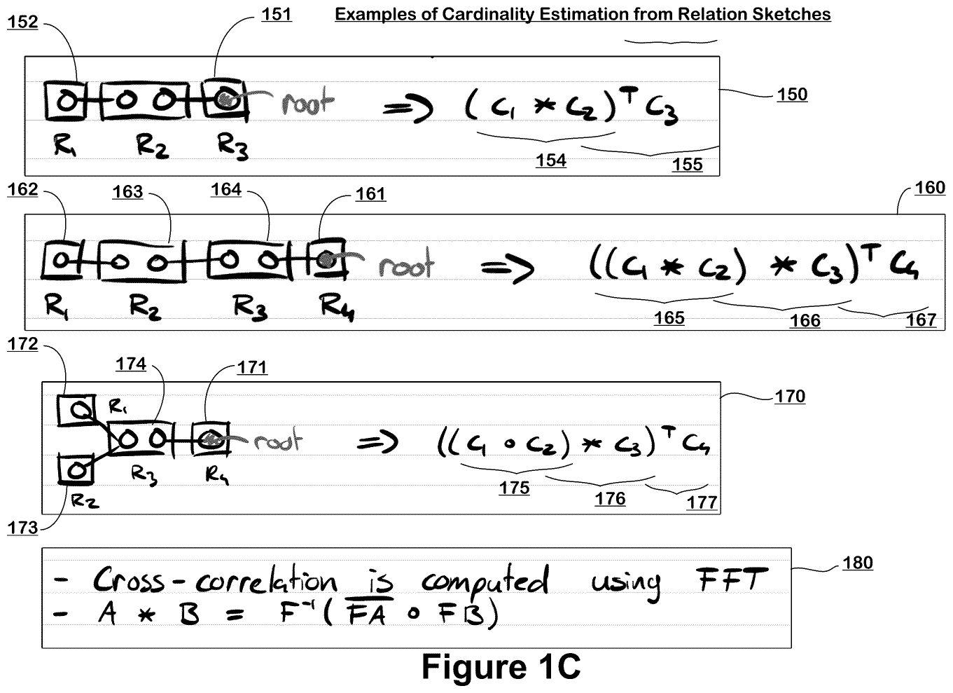

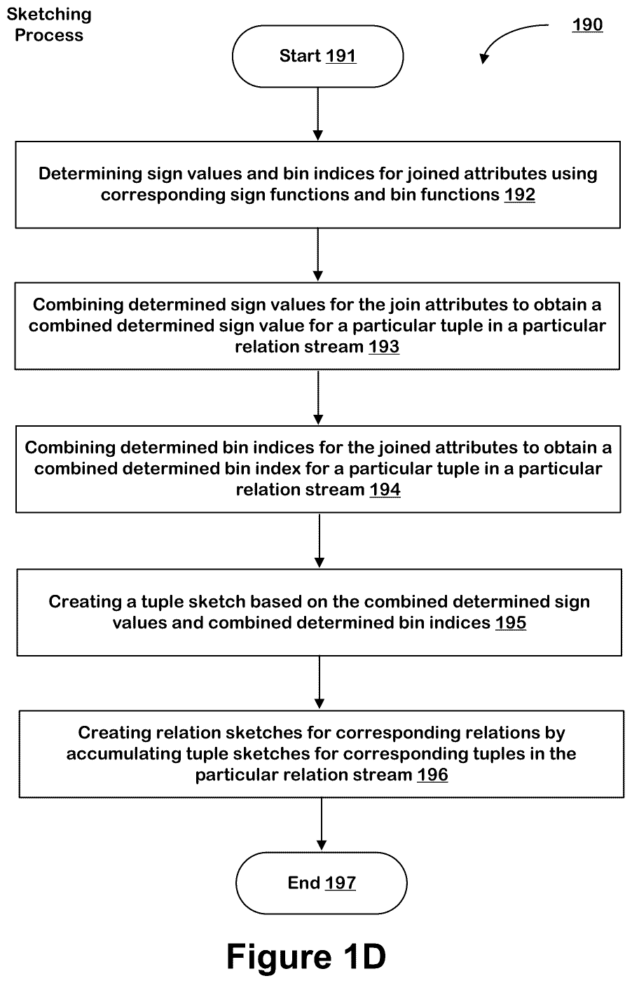

The analysis of streaming data has amassed considerable attention, driven by the increasing demand for real-time data processing, and the remarkable advancements in algorithms that enable efficiently querying and analyzing data streams under memory constraints. Streaming data refers to data that is received sequentially and is often too large to be stored in its entirety, hence requiring algorithms that can process the data on-the-fly. Efficiently providing answers to queries over streaming data is vital in numerous application environments, including recommendation systems, smart cities, network traffic monitoring, natural language processing, and analysis of market data in financial systems. Our focus on the streaming data setting stems from its generality. Streaming algorithms are not only effective in streaming settings but also seamlessly extend their applicability to non-streaming scenarios. The technology disclosed provides a novel approach to the problem of estimating a crucial collection of complex queries within the general streaming data framework depicted in FIG. 1A and elaborated upon below. The technology disclosed provides systems and methods to estimate cardinality of a multi-join query over relations in a database. Joins in the multi-join query connect joined attributes across the relations. FIG. 1B presents an example of creating relation sketches using the technology disclosed. FIG. 1C presents various examples to estimate cardinality (i.e., the number of rows returned) of a multi-join query from relation sketches that are created using the technology disclosed.

FIG. 1A presents a high-level architecture of creating sketches of relations. Streams of data for respective relations R0, R1 and Rr-1 are passed to the stream query-processing engine 101. The stream query-processing engine 101 can comprise memory 102 to store sketches for respective relations R0, R1 and Rr-1. A query “Q” (103) over multiple-relations is provided as input to the stream query-processing engine 101. The stream query-processing engine 101 includes logic to create sketches for relations and use those relation sketches to estimate (104) of cardinality of the multi-join query “Q”.

FIG. 1B presents an example of creating sketches of relations using the technology disclosed. A relation 111 (labeled as Table 1) is shown with two joined attributes “A” and “B”. The relation 111 is joined with one or more other relations (not shown in FIG. 1B) via the joined attributes “A” and “B”. In one example, the relation 111 is joined to a second relation (not shown in FIG. 1B) via a joined attribute “A” and the relation 111 is joined to a third relation (not shown in FIG. 1B) via joined attribute “B”. Three tuples of the relation 111 are shown in the example. The tuples are labeled as tuple 1 (113), tuple 2 (114) and tuple 3 (115). It is understood that the relation can have many more tuples. Only three tuples are shown for illustration purpose. The attribute names “A” and “B” are collectively labeled as joined attributes (112). The tuple 1 (113) is also represented by a circle notation. The tuple 2 (114) is represented by a rectangular notation and tuple 3 (115) is also represented by a triangle notation. Sign values and bin indices for the joined attributes “A” and “B” are determined using sign hash and bin hash functions respectively. As an example, a table labeled as sign hash 1 (120) presents mapping of values for joined attribute “A” to corresponding sign values. A circle, a rectangle and a triangle symbol in the table 120 identifies values of attribute “A” in corresponding tuples in the relation 111. Similarly, a table labeled as sign hash 2 (122) maps the values for join attribute “B” to corresponding sign values. Tables 124 and 125 respectively map the values for joined attributes “A” and “B” to corresponding bin indices.

FIG. 1B also shows creation of tuple sketches for the three tuples (113, 114 and 115). For example, a tuple 1 sketch (130) is created by multiplying the two sign values (identified by labels 141 and 142) for the two attributes in tuple 1 (113). The result of the multiplying the two negative one (−1) values results in a positive one answer (+1) (131). The location of the bin or the bin index is determined by adding bin values (identified by labels 143 and 144) from the two bin hash functions. A modulus of result of the addition (i.e., 7) is determined using a size of the tuple sketch. In this example, the size of the tuple sketch and relation sketch is selected as m=5, where m represents a size of the sketch. A larger sketch size can increase the quality of the sketch but it will require more storage space. Therefore, a tradeoff is typically made between the size of the sketch and the memory requirements or the amount of storage required. The result of the modulus operation (132) i.e., “2” is the bin index. Therefore, the sign value “+1” (131) is stored at the bin location identified by the bin index “2” (132). A graphical illustration of sketch tuple 130, shows a value “+1” stored in the second location (i.e., bin index value “2”), identified by a numeral 133. Note that in this example, 1-based indexing of the sketches is used. Zero-based indexing can also be used for sketches. Tuple 2 sketch 134 and tuple 3 sketch 138 are created using similar logic as described above. Finally, the values from all tuple sketches are accumulated to create the relation or table sketch 140. Note that when tuple sketches are accumulated to create relation sketch, the values of tuple sketches that fall in the same bin in the relation sketch can either augment each other (e.g., a “+1” will add to another “+1” to results in “+2”) or they can cancel each other (e.g., a “+1” will cancel a “−1” in the same bin). In another implementation, the values of tuple sketches, calculated as described-above are directly accumulated (or stored) in the relation sketch 140. In this implementation, the requirement of storage space can be reduced by not creating the tuple sketches and directly accumulating (in the relation sketch) sign values at the bin indices identified for corresponding tuples. The sketching process described above creates relation sketches that store (or encode) information required to estimate the cardinality of a multi-join query. The details of the estimation process are described below with reference to FIG. 1C.

FIG. 1C presents examples of estimating cardinality from relation sketches. FIG. 1C presents three examples including graphs (labeled as 150, 160 and 170) representing joined attributes as nodes. Two nodes (representing joined attributes) are connected via an edge in the graph if corresponding relations are joined via joined attributes. The graphs illustrate the process for estimation of cardinality using relation sketches. Each of the three examples in FIG. 1C shows relations (tables) joined via joined attributes. The first example (labeled 150) shows joined attributes of three relations R1, R2 and R3. The relations R1 and R2 are connected by joined attributes while relations R2 and R3 are connected by joined attributes. Any joined attribute connecting the relations can be selected as a root attribute and corresponding node is selected as a root node.

The first example (labeled as 150) illustrated in FIG. 1C presents three relations R1, R2 and R3 joined in a multi-join relationship such that relation R1 is joined to relation R2 via a first joined attributed and relation R2 is joined to relation R3 via a second joined attribute. In this example 150, illustrated in FIG. 1C, a joined attribute 151 joining the relations R2 and R3 is selected as a root attribute. Thus, the corresponding node (identified by a label 151) is selected as the root node in the graph. Once a root join attribute is selected, the cardinality estimation method disclosed, includes traversing from the one or more leaf nodes (representing joined attributes) towards the selected root node. In the first example (150), the leaf attribute is the joined attribute 152 of relation R1 joining the relation R1 with relation R2. When traversing from the leaf node to the root node, if the joined attribute establishes a parent-child relationship between the relations joined by the joined attribute, then a cross-correlation is computed between the sketches of the respective relations joined in the parent-child relationship. The computation of cross-correlation between sketches of relations R1 and R2 is shown in FIG. 1C as identified by a label 154. The next step of the traversal from the lead node to the root node, actually involves the root node i.e., the joined attribute of relation R3. When at least one of the joined attributes in the traversal is a root node then a dot product is calculated between sketches of the corresponding parent and child nodes connected by the joined attribute. As shown in FIG. 1C, a dot product is calculated for the result (154) of cross-correlation between sketches c1 (sketch of relation R1) and c2 (sketch of relation R2) and the sketch c3 of relation R3 (as shown by a label 155). The output of the dot product operation is a scalar value and represents an estimate of the cardinality of the multi-join query.

The second example (labeled as 160) illustrated in FIG. 1C presents four relations R1, R2, R3 and R4 joined in a multi-join relationship such that relation R1 is joined to a relation R2 via a first joined attribute (162), the relation R2 is joined to a relation R3 via a second joined attribute (163) and the relation R3 is joined to relation R4 via a third joined attribute (164). A joined attribute of relation R4 is the root node 161 in the graphical representation of the joins in the second example. Note that any node representing a joined attribute in the graph can be selected as a root node. In this example, the joined attribute of relation R4 is selected as the root node. As described above, the method includes traversing from the leaf node to the root node in the graphical representation of the multi-join query. As the leaf node 162 representing the joined attribute in relation R1 is joined to a joined attribute of relation R2 in a parent-child relationship, a cross-correlation is calculated between sketches of relation R1 and relation R2 as shown by a label 165. The traversal along the graph then continues towards the root node. The joined attribute of relation R2 (163) is joined to the joined attribute of relation R3. This join is represented as a parent-child relationship in the graph. Therefore, the result of the operation 165 is then used to calculate a cross-correlation with sketch c3 of relation R3 as shown by a label 166 in the FIG. 1C. Finally, the joined attribute of relation R3 is joined with the join attribute of relation R4. As the joined attribute of relation R4 is represented as a root node 161 in the graph, a dot product is calculated between the sketch that is obtained as output of operation 166 and the sketch of relation R4 as identified by a label 167. The result of the dot product operation (167) is a scalar value representing an estimate of the cardinality of the multi-join query.

The third example (labeled as 170) illustrated in FIG. 1C presents four relations R1, R2, R3 and R4 joined in a multi-join relationship such that relation R1 is joined to relation R3 via a first joined attribute (172). The relation R2 is joined to relation R3 via a second joined attribute (173). The relation R3 is joined to a relation R4 via a third joined attribute (174). Relations R1 and R2 are siblings as both have joined attributes that join the respective relations to the same parent relation R3. The joined attributed in relation R4 is selected as the root node (171). As described above, the method includes traversing from the leaf node to the root node in the graphical representation of the multi-join query. There are two leaf nodes labeled as 172 and 173 in the graph in the third example labeled as 170. The method in this case comprises calculating a Hadamard product between relation sketches of relations that are siblings. This operation is represented as an operation 175 in FIG. 1C. When traversing up towards the root node, cross-convolution between the result of the calculation 175 and the sketch of relation R3 is calculated. The joined attribute of relation R3 is the parent of the joined attributes of relations R1 and R2. This operation is shown by a label 176. Finally, the join attribute of relation R3 is joined with the joined attribute of relation R4. As the joined attribute of relation R4 is represented as a root node 171 in the graph, a dot product is calculated between the sketch that is obtained as output of operation 176 and the sketch of relation R4 as identified by a label 177. The result of the dot product operation (177) is a scalar value representing an estimate of the cardinality of the multi-join query.

The cross-correlation can be calculated using Fast Fourier transform (FFT) operation. Suppose “A” and “B” represent sketches of two relations. The calculation of cross-correlation between the sketches A and B is shown at the bottom of FIG. 1C, identified by a label 180. The cross-correlation (A*B) is calculated as a Hadamard product between conjugate of Fourier transform of sketch A and Fourier transform of sketch B. An inverse Fourier transform of the result is then calculated to determine the final cross-correlation result between the two sketches as identified by a label 180 in FIG. 1C.

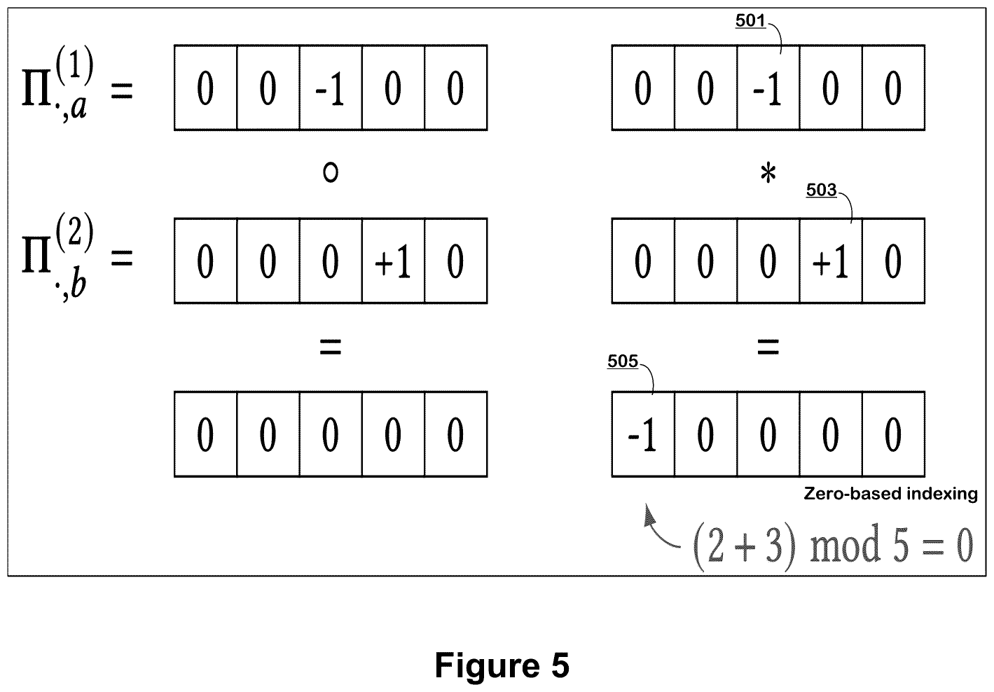

The technology disclosed includes logic to create sketches such that a sketch retains a non-zero value character at a bin index specified by the determined bin index. The technology disclosed achieves this by utilizing circular convolution paired with circular cross-correlation in inference for estimating cardinality of multi-join queries. The circular convolution is used in the sketching process as shown in FIG. 1B. With circular convolution, a resulting tuple sketch has a product of non-zero entries (e.g., 141 and 142 in FIG. 1B or 501 and 503 in FIG. 5, etc.) in the bin that corresponds to the sum of the non-zero indices, modulo m (i.e., the size of the sketch). This is shown in the example in FIG. 1B when creating tuple sketches 130, 134 and 138. Existing techniques use Hadamard product for this operation that can cause loss of information. A comparison of how the circular convolution (as used by the technology disclosed) preserves information in sketches and use of Hadamard product (in other techniques) can cause of loss of information is presented in FIG. 5. Further details of how the technology disclosed uses the circular convolution to preserve information is presented in the following sections. During inference, when estimating the cardinality of multi-join queries, the technology disclosed uses cross-correlation (or circular cross-correlation) as explained above with reference to various estimation examples presented in FIG. 1C. Therefore, the technology disclosed provides an efficient and fast method for estimating the cardinality of multi-join queries that also preserves information in sketches. Results of experiments conducted (presented below), show that the proposed cardinality estimation technique provides faster updates to sketches of relations while preserving information as compared to other cardinality estimation techniques.

FIG. 1D presents the operations of the process to calculate relation sketches. A process flowchart (or process flow diagram) 190 presents process operations starting from a start operation 191. The technology disclosed implements this method to estimate cardinality of a multi-join query over relations in a database. The joins in the multi-join query connect joined attributes across the relations in a database. The method includes determining, for joined attributes of a particular relation with a particular relation stream (or tuple stream), sign values and bin indices for the joined attributes of the particular relation using corresponding sign functions and bin functions initialized for the joined attributes of the particular relation (operation 192). The method includes combining the determined sign values for the joined attributes to obtain a combined determined sign value for a particular tuple in the particular relation stream or tuple stream (operation 193). The method includes combining the determined bin indices for the joined attributes to obtain a combined determined bin index for the particular tuple in the particular relation stream or tuple stream (operation 194). The method includes creating a tuple sketch for the particular tuple in the particular relation stream based on the combined determined sign value and the combined determined bin index (operation 195). The tuple sketch is a combination of the determined sign values and the determined bin indices for the joined attributes and retains a non-zero value character at a bin index specified by the determined bin index. The method includes creating relation sketches for corresponding relations (operation 196). The relation sketch for the particular relation is created by accumulating, on a relation basis, tuple sketches of corresponding tuples in the particular relation stream (or tuple stream). The relation sketches calculated using the above-described method can then be used to estimate cardinality of multi-join queries across these relations. The process to calculate cardinality is presented in FIG. 1C. The process ends at an operation 197. The technology disclosed provides an efficient system and method for operating the system to create sketches of relations. Further details of the technology disclosed are presented in the following sections.

### Streaming Query-Processing Scheme

The rise of data-intensive applications has created a need for data structures that can handle massive volumes of data efficiently. This context motivated the emergence of synopsis data structures, a family of data structures designed to represent large quantities of data with sublinear space complexity, which is imperative in the given context. Examples include random samples, histograms, wavelets, and sketches, all of which are actively being researched as a means of analyzing and querying streaming data. These algorithms operate by generating a compressed representation of the original data, which can then be utilized to estimate a specific property or a set thereof. For example, the popular Bloom Filter is widely used for membership testing, while the Count-Min sketch is commonly used for frequency estimation. Both of these methods are examples of sketches. Besides their supported queries, various factors differentiate sketching methods, including sketch size, sketch initialization time, update time, and inference time (further details are provided in the following sections). These characteristics serve as catalysts for diverse research avenues and are crucial to consider when utilizing or developing a sketching method that is tailored to a specific use case.

Aside from basic statistical properties such as count, sum, and mean, much useful information from a data stream is derived from its frequency distribution, or histogram. This becomes particularly relevant when we need to compare or estimate functions across multiple data sets, such as the number of shared items. Frequency-based sketches are a class of sketching methods specifically designed for estimating functions of the frequency vector. Among these, the AMS (Alon-Matias-Szegedy) sketch, also known as Tug-of-War sketch, stands out as a prime example, renowned for its established reputation of being both simple and remarkably effective in a wide array of applications. The AMS sketch was initially introduced to estimate the second frequency moment of a data stream, but it was later demonstrated to also estimate the cardinality of any equi-join between two relations.

Interestingly, it turns out that many important functions on the frequency vector can be expressed as the cardinality of an equi-join. This equivalence is an important driver behind the development of sketches, often seen as an approximate query processing (AQP) technique. One particularly relevant use case is estimating the join cardinality, which is crucial for query optimizers to efficiently assess the cost of candidate physical join plans. The challenge of determining an appropriate join order is a highly researched problem in the field of databases, and the methods employed typically rely on cardinality estimates as the primary input.

Two techniques or methods emerged a few years after the introduction of the AMS sketch. First proposed the Count sketch, which divides estimates into “buckets” instead of computing the mean of multiple independent and identically distributed (i.i.d.) estimates. This approach makes the sketch more accurate for skewed data and dramatically speeds up its updates. Second proposed a generalization of the AMS sketch that enables the cardinality estimation of multi-join queries, thus considerably expanding the algorithm's applicability.

Although both methods have gained popularity for their respective advantages, the existing literature has highlighted the task of integrating all these benefits into a unified approach as a challenging and unresolved problem. The specific challenge lies in effectively handling multi-join queries with fast updates. This challenge becomes even more significant when considering the prevalence of such multi-joins, as they constitute the majority of queries (further details of database size statistics are presented below). The difficulty of combining the Count sketch with the AMS-based multi-join query estimation method arises from the use of binning, as discussed in the section presenting the method, yet binning is essential for achieving the benefits of the Count sketch.

The proposed method relies on the intuitive observation that the operation used to merge single-item AMS sketches to form sketches of tuples, the Hadamard product (see Definition 4, below), is incongruous with the sparse nature of the Count sketch. In essence, when two Count sketches undergo the Hadamard product, the resulting sketch will likely lose information due to the sparsity of the Count sketches.

The technology disclosed employs circular convolution (see Definition 2, below) instead of the Hadamard product for counting tuples in a data stream. We show that, unlike the Hadamard product, this operation ensures the preservation of information from the operands in the resulting Count sketch. This is complemented by incorporating circular cross-correlation (see Definition 5, below) in the estimation procedure. Our method not only exhibits superior estimation accuracy when applied to real data and queries, but also operates within the same memory constraints. Moreover, the technology disclosed significantly improves the time complexity of the sketch update process, enabling estimates to be computed orders of magnitude faster.

We prove that our estimator is unbiased and offers error guarantees. Importantly, our method does not require prior knowledge of the data distribution. Our empirical findings support the practical applicability of the proposed method, underscoring its significant advancement in addressing the aforementioned open problem.

### Methodologies and Notation

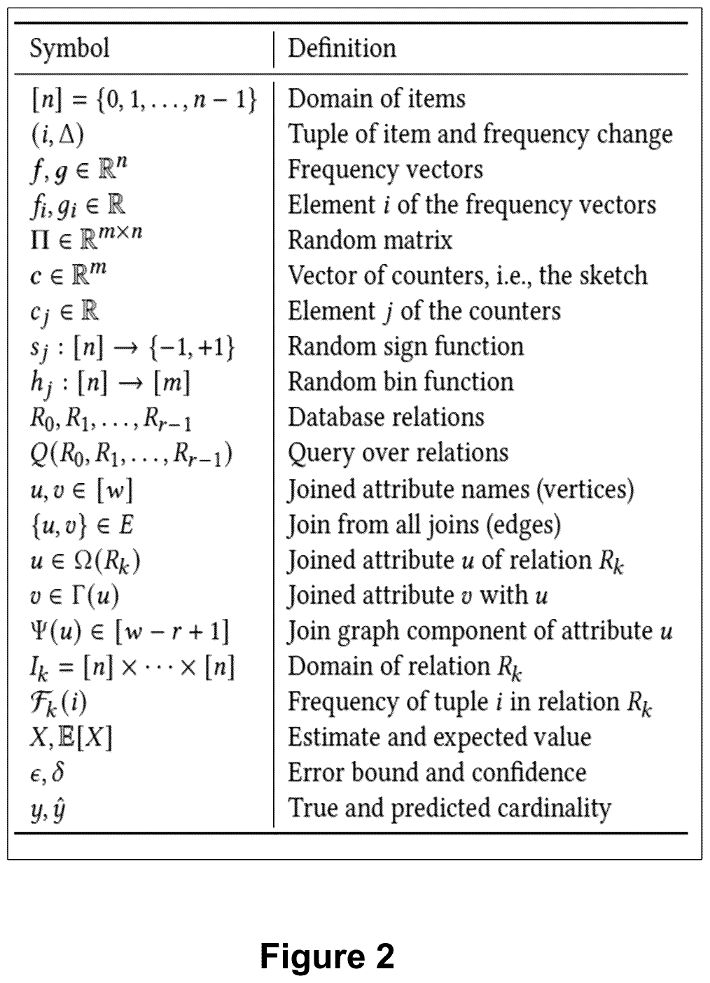

This section provides the necessary background and introduces the key methodologies and notation used in this work. For an overview of the notation see table 1 presented in FIG. 2. These concepts and methodologies set the foundation for the introduction of our proposed method. The notations in FIG. 2 are also presented below:

### Notation

| Symbol | Definition |
|---|---|
| [n] = {0, 1, . . . , n − 1} | Domain of items |
| (i, Δ) | Tuple of item and frequency change |
| f, g ∈ Rⁿ | Frequency vectors |
| fᵢ, gᵢ ∈ R | Element i of the frequency vectors |
| Π ∈ R^{m×n} | Random matrix |
| c ∈ R^{m} | Vector of counters, i.e., the sketch |
| cⱼ ∈ R | Element j of the counters |
| sⱼ: [n] → {−1, +1} | Random sign function |
| hⱼ: [n] → [m] | Random bin function |
| R₀, R₁, . . . , Rᵣ₋₁ | Database relations |
| Q(R₀, R₁, . . . , Rᵣ₋₁) | Query over relations |
| u, v ∈ [w] | Joined attribute names (vertices) |
| {u, v} ∈ E | Join from all joins (edges) |
| u ∈ Ω(Rₖ) | Joined attribute u of relation Rₖ |
| v ∈ Γ(u) | Joined attribute v with u |
| Ψ(u) ∈ [w − r + 1] | Join graph component of attribute u |
| Iₖ = [n] × . . . × [n] | Domain of relation Rₖ |
| Fₖ(i) | Frequency of tuple i in relation Rₖ |
| X, [symbol] [X] | Estimate and expected value |
| ϵ, δ | Error bound and confidence |
| y, ŷ | True and predicted cardinality |

### Streaming Data

The technology disclosed focuses on streaming data analysis, a prominent application area for synopsis data structures, which involves real-time processing of data that arrives at a high frequency. Streaming data naturally arises in many big data applications, including network traffic monitoring, recommendation systems, natural language processing, smart cities, and analysis of market data in financial systems. Algorithms for streaming data are designed to handle data that can only be observed once, in arbitrary order, as it continuously arrives. Consequently, these algorithms must be highly efficient in processing each input, while utilizing limited memory resources, to keep up with the rapid influx of new data.

By presenting the technology disclosed within the streaming data setting, we establish its applicability to a broad range of scenarios. This is because streaming algorithms are also applicable when multiple data accesses or a specific access order are allowed. Inversely, algorithms that require multiple data accesses or a specific access order, like many learning-based methods, clearly do not apply in a streaming data setting. Even when a streaming algorithm is not strictly necessary, optimizing for fewer data accesses remains advantageous because it minimizes potentially costly I/O operations.

In this section, formulation of the problem addressed by the technology disclosed is presented: consider a vector f(t)∈Rⁿ, which is assumed too large to be stored explicitly and is therefore presented implicitly in an incremental fashion. Starting as a zero vector, f(t) is updated by a stream of pairs (iₜ, Δₜ) which increments the iₜ-th element by Δₜ, meaning that fᵢ_{ₜ}(t)=fᵢ_{ₜ}(t−1)+Δₜ, while the other dimensions remain unchanged. The items it are members of the domain [n]={0, 1, . . . , n−1}; Δₜ∈R are the changes infrequency and f(t) is called the frequency vector. At any time t, a query may request the computation of a function on f(t). Specific streaming settings are further classified by their type of updates, as follows:
cash-register: Δₜ>0 on every update;
strict turnstile: for some updates Δₜ can be negative, but f(t)≥0 for all i and t;
general turnstile: both updates and entries of the vector f(t) can assume negative values at any time t>0.

The methods we discuss herein, utilize synopsis data structures to efficiently handle data streams, eliminating the need to explicitly store and compute over f(t) to answer a set of supported queries. In the following section, we will introduce a group of sketching techniques known as linear sketches. This family of methods, which includes the approach proposed in this paper, is designed to support the most general streaming setting, i.e., the general turnstile.

### Linear Sketching

Sketching techniques are a popular set of methods for dealing with streaming data and approximate query processing. Both the baselines and the method proposed in this paper are linear sketches, meaning that the summaries they generate can be represented as a linear transformation of the input. In contrast, the Bloom Filter serves as a classic example of a non-linear sketch.

Formally, for a given vector x∈Rⁿ, we define a linear sketch as a vector obtained by Πx, where Π∈R^{m×n} is some random matrix, and m<<n. The linearity of the transformation offers notable advantages: it allows for processing items in any order and combining different sketches through addition. This enables efficient handling of data and supports map-reduce style processing of large data streams. In every sketching method, the random matrix is thoughtfully designed to enable the estimation of one or multiple functions over x, utilizing only its “summary” captured by Πx, thereby eliminating the necessity for accessing x itself. When sketching techniques are used in a streaming scenario they are often referred to as frequency-based sketches, where the input vector x is the frequency vector f(t) defined above. Hereafter, we will omit the time argument from the frequency vector for brevity.

At this point, one naturally wonders: how can we transform the vector f of size n, which is already considered too large, using a matrix Π that is even larger with size mn? Streaming algorithms cleverly represent the matrix Π succinctly using hash functions, enabling them to generate just the column of Π that is needed to add a given item. Further details on this process will be provided later. Furthermore, it is crucial to ensure that the sketch is efficiently updated as f changes, i.e, as new items stream in. This can be achieved by making Π sparse, as we will explore shortly. The effectiveness and versatility of a sketching method primarily relies on the following key properties:
Sketch size: The total number of counters and random seeds required by the sketch, determined by the parameter m.
Initialization time: The time it takes to initialize the sketches. Typically, this involves simply setting a block of memory to zeros, and sampling the random seeds for the hash functions.
Update time: In streaming settings, algorithms must keep pace with the high influx of items. The update time determines the highest item throughput rate that can be sustained.
Inference time: The time it takes to compute an estimate from the generated sketches.
Accuracy: It is crucial to understand the accuracy of an estimator for a given memory budget (limiting the sketch size) and throughput requirement (constraining the update time).
Supported queries: Each sketch is designed to enable estimation of a specific set of functions on the input vector. Typically, a query-specific procedure needs to be performed on the sketch to approximate the value of a particular function.

In the following, we will describe some important sketching methods from the existing literature that have particularly space- and time-efficient ways of representing and computing Πf.

### AMS Sketch

The AMS sketch, also referred to as the Tug-of-War or AGMS sketch, is a pioneering technique for frequency-based sketching that was first introduced by Alon, Matias, and Szegedy (AMS). The method was originally proposed as a way to estimate the second frequency moment F₂ of a data stream, where F₂=∥f∥₂²=Σᵢ₌₀ⁿ⁻¹ fᵢ² and f is the frequency vector of the stream as defined in Section 2.1. The AMS sketch is represented by a vector c, containing m=O(1/∈²) counters cⱼ, for j∈[m], where 0<∈<1 is the relative error bound. The counters are i.i.d. random variables obtained by cⱼ=Σᵢ₌₀ⁿ⁻¹ fᵢsⱼ(i), where each sⱼ:[n]→{−1, +1} is drawn from a family of 4-wise independent hash functions (see Definition 1, below). These hash functions are used to compute the random projection Πf without representing Π explicitly, since Π_{j,i}=sⱼ(i). To establish a confidence level δ, one can take the median of O(log 1/δ) independent estimates. The overall method then requires only O((1/∈²)log 1/δ) counters. Taking the median of i.i.d. estimates, sometimes called the “median trick”, is universal among sketching methods because it is an effective way to rapidly improve the confidence level of an estimate by the Chernoff Bound. We will, therefore, revisit this concept in the subsequent discussions of other methods.

Definition 1 (k-wise independence). A family of hash functions H={h: [n]→[m]} is said to be k-wise independent if for any k distinct items x₀, . . . , xₖ₋₁ the hashed values h(x₀), . . . , h(xₖ₋₁) are independent and uniformly distributed in [m].

Note that

$$\frac{1}{m} 〈 Π f , Π f 〉$$

is an unbiased estimator of F₂. In fact, it can be demonstrated more generally that for any two vectors f and g, the normalized inner product of their AMS sketches

$$\frac{1}{m} 〈 Π f , Π g 〉$$

is an unbiased estimator for their inner product [symbol] f, g [symbol] . Notably, when f and g correspond to the frequency vectors of a given attribute of two database relations, this estimated value corresponds to the equi-join size of these relations over that attribute. Theorem 1 formally states the expectation, and bounds the variance of the AMS sketch.
Theorem 1 (AMS sketch). For any vectors f, g∈Rⁿ and a random matrix Π∈R^{m×n} constructed by 4-wise independent hash functions sⱼ:[n]→{−1, +1} for j∈[m] and Π_{j,i}=

$${s}_{j} ( i ) , we have : 𝔼 [ \frac{〈 Π f , Π g 〉}{m} ] = 〈 f , g 〉 , ∧ Var ( \frac{〈 Π f , Π g 〉}{m} ) \leq \frac{2}{m} {‖ f ‖}_{2}^{2} {‖ g ‖}_{2}^{2}$$

### Count Sketch

In order to ensure fast sketch updates, i.e., sublinear with respect to its size m, it is desirable for sketching methods to use a sparse linear transformation H when processing input vectors. However, note that the AMS sketch requires changes in all m counters for each update. Consequently, the accuracy of the estimator is constrained by the need to maintain a throughput that corresponds to the rate of incoming items as well as the available memory budget.

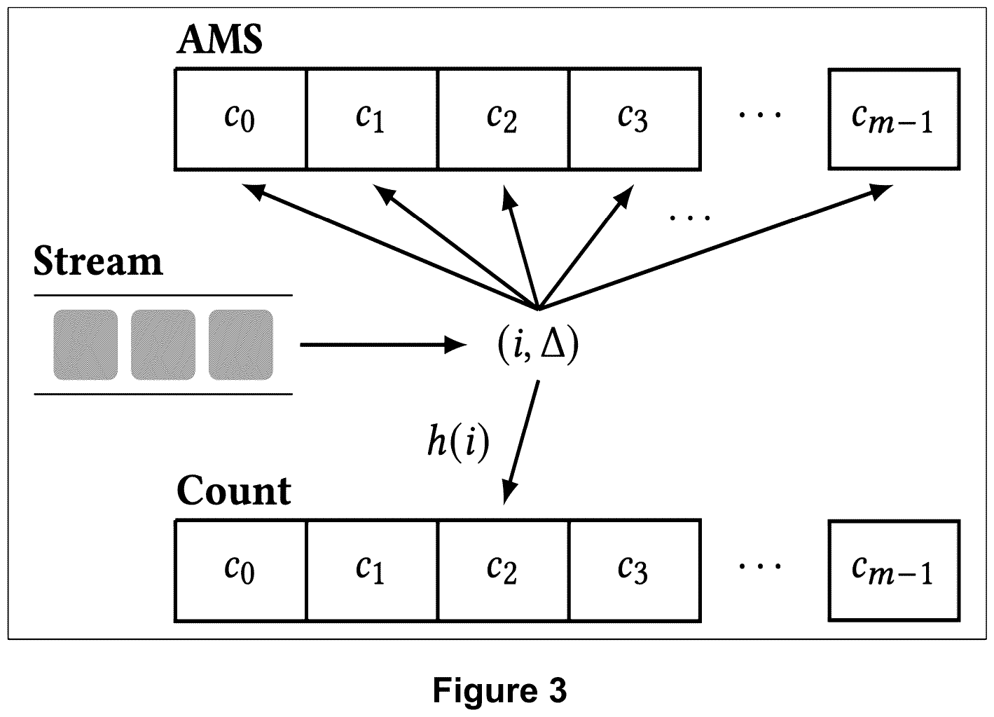

The Count sketch is another linear sketching method that emerged after AMS and overcomes this limitation by allowing the update time to be independent of the sketch size. It achieves this by employing a technique called the “hashing trick,” which ensures that only one counter per estimate is modified during each update. As a result, the Count sketch improves the update time complexity from O((1/∈²)log 1/δ) to just O(log 1/δ), while maintaining not only the same error bounds, but also the same space and inference time complexities as the AMS sketch. The AMS sketch and Count sketch update procedures are compared in FIG. 3. FIG. 3 presents a comparison of the AMS and Count sketches performing a sketch update for an item in the (tuple or relation) stream. Although the Count sketch was originally introduced for the heavy hitter's problem, the same hashing trick can be applied to speed up the AMS sketch, which is commonly known as the Fast-AMS sketch.

The value of each counter in the Count sketch is given by cⱼ=Σ_{i=0:h(i)=j}ⁿ⁻¹ fᵢs(i), where h: [n]→[m] is a random bin function drawn from a family of 2-wise independent hash functions, and s: [n]→{−1, +1} is again a random sign function drawn from a family of 4-wise independent hash functions. The corresponding random matrix Π is specified by Π_{j,i}=s(i)1(h(i)=j). Notice that H has only one non-zero value per column, making it highly sparse. Also, the Count sketch requires only one sign and bin hash function per estimate, regardless of the required precision, resulting in a further reduction in memory usage. An estimate is obtained by taking the inner product between sketches. Theorem 2 formally states the expectation and bounds the variance of the Count sketch.
Theorem 2 (Count sketch). For any vectors f, g∈Rⁿ and a random matrix Π∈R^{m×n} constructed by 4-wise independent hash function s: [n]→{−1, +1} and 2-wise independent hash function h: [n]→[m] with Π_{j,i}=s(i)1(h(i)=j), we have:

$$𝔼 [ 〈 Π f , Π g 〉 ] = 〈 f , g 〉 , ∧ Var ( 〈 Π f , Π g 〉 ) \leq \frac{2}{m} {‖ f ‖}_{2}^{2} {‖ g ‖}_{2}^{2}$$

The Count sketch has also been shown to outperform the AMS sketch in estimation precision for skewed data distributions. This is because the Count sketch is able to separate out the few high frequency components with high probability. This is an important trait, as it has been widely acknowledged in the literature that the majority of real-world data distributions exhibit a skewed nature. We further discuss this topic in one of the following sections.

### Extensions to the Count Sketch

The Count sketch was originally introduced for single-dimensional data which is represented by the frequency vector f. More recently, however, several extensions to the Count sketch have been proposed which enable its usage for higher-dimensional data represented by a frequency tensor F instead. The most notable extensions are the Tensor sketch and the Higher-Order Count (HOC) sketch. Both methods set out to reduce the computational complexity of machine learning applications. The Tensor sketch was used to approximate the polynomial kernel, but finds its origin in estimating matrix multiplication. The HOC sketch was introduced to compress the training data or neural network parameters, in order to speed up training and inference processes.

For each incoming item of the stream, both methods start by encoding all modes separately using independent instances of the Count sketch. They differ in the way these individually sketched modes are combined: the Tensor sketch employs circular convolution (see Definition 2), generating a sketch vector, whereas the HOC sketch utilizes the tensor product to produce a sketch tensor of the same mode but with reduced dimensions compared to F. The use of the tensor product ensures that mode information about the sketched data is preserved, at the cost of an exponential increase in sketch size with the number of tensor modes. The circular convolution, in contrast, preserves the dimensionality of the sketch vector for any number of tensor modes, i.e., it maps tensors to vectors.

In the context of databases, COMPASS uses HOC sketches to estimate the cardinality of multi-join queries. They additionally propose a method to approximate HOC sketches by merging Count sketches. While they show promising results for query optimization, their estimation method lacks theoretical error guarantees. Moreover, we show that (in a following section), in practice, our proposed method achieves significantly higher estimation accuracy. The Tensor sketch (see Definition 3) is the most related to our method, however, our method and application are novel and solves an important open problem in the streaming and databases community, as will be detailed in the following Section.

Definition 2 (Circular convolution). The circular convolution x*y of any two vectors x, y∈C^{m} is a vector with elements given by (x*y)ⱼ=Σᵢ₌₀^{m-1} xᵢy_{(j-i)modm} for all j∈[m].
Definition 3 (Tensor sketch). Consider any mode d tensor F∈Rⁿ^{^{d}} and random matrix Π∈R^{m×n}^{^{d}} constructed by 2-wise independent hash functions hₖ: [n]→[m] and 4-wise independent hash functions sₖ: [n]→{−1, +1} for each mode k∈[d]. Let Π_{j,i}=S(i)1(H(i)=j) with the following decomposable hash functions: H(i)=
Then, the Tensor sketch is given by ΠF.
Multi-Join with AMS Sketches

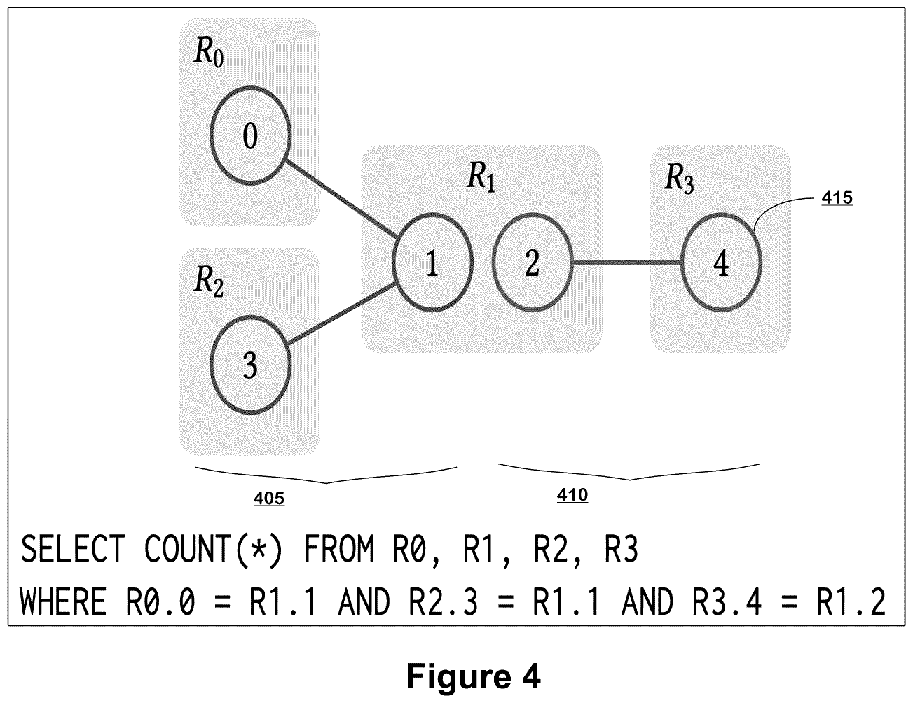

Another significant advancement in linear sketching techniques emerged around the same period as the Count sketch. Previously, a generalization of the AMS sketch has been proposed that enables the estimation of complex multi-join aggregate queries, such as count and sum queries. These estimates are useful for big data analytics and query optimization. The proposed method addresses the scenario where a query Q(R₀, R₁, . . . , Rᵣ₋₁) involves multiple relations Rₖ for k∈[r]. An example is illustrated in FIG. 4, which provides an intuitive visualization of this type of complex query as a disconnected, undirected graph. In this abstraction, each vertex corresponds to an attribute, edges represent the joins between them, and attributes are grouped to form relations. FIG. 4 provides an example join graph and corresponding SQL query. Additional attributes in each relation, not involved in the join, are omitted for clarity. An example, multi-join query for the relations in FIG. 4 is presented below:
SELECT COUNT(*) FROM R0, R1, R2, R3
WHERE R0.0=R1.1 AND R2.3=R1.1 AND R3.4=R1.2

The technique generates sketches for each relation by iterating over all the tuples i in each relation once. This iterative traversal of the tuples aligns with the streaming data scenario described above, enabling the sketches to be created on-the-fly as the relations are updated. The sketch cₖ for relation Rₖ is given by Equation 1, below:

$${c}_{k , j} = {\sum }_{i ∈ {I}_{k}}^{□} {F}_{k} ( i ) {\prod }_{u ∈ Ω ( {R}_{k} )}^{□} {\prod }_{v ∈ Γ ( u )}^{□} {s}_{j , \{ u , v \}} ( {i}_{u} )$$

Where we use the following notation: i represents a tuple that belongs to the domain Iₖ of relation Rₖ; Iₖ is the cross product of item domains [n]× . . . ×[n] for each joined attribute of relation Rₖ; Fₖ (i) gives the frequency of tuple i in relation Rₖ; iᵤ denotes the value in tuple i for attribute u; u is an attribute from the set of joined attributes of Rₖ in the query, denoted as Ω(Rₖ) (for example, Ω(R₁)={1,2} in FIG. 4); v is an attribute from the set of attributes joined with u, denoted as Γ(u) (for example, Γ(1)={0,3} in FIG. 4). We represent a join between two attributes with {u, v}. Both u, v∈[w] are from the set of all joined attributes. Our notation assumes that all attributes are globally unique, which can easily be achieved in practice, for instance, by concatenating the relation and attribute names. Moreover, we assume that joins are non-cyclic, a self-join is thus represented as a join with a fictitious copy of the relation. It is worth noting that the copy does not need to be physically created, this is done solely to simplify the notation. Note also that the functions F and 2 are defined for a specific query Q. We omit this dependence in the notation for brevity, as it is evident from their definitions.

Once the sketches are created, a query estimate is derived by performing the element-wise multiplication of the sketches, often referred to as the Hadamard product of sketches (see Definition 4, below). This is followed by calculating the mean over the counters. Formally, this can be expressed as:

$$X = \frac{1}{m} {\sum }_{j = 0}^{m - 1} {\prod }_{k = 0}^{r - 1} {c}_{k , j} ,$$

where X is an unbiased estimate of the cardinality of query Q. The expectation and variance of X are formally stated in Theorem 3 (below).
Definition 4 (Hadamard product). The Hadamard product x∘y, or element-wise multiplication, of any two vectors x, y∈C^{m} is a vector with elements given by (x∘y)ⱼ=xⱼyⱼ for all j∈[m].
Theorem 3. Given an acyclic query of relations Rₖ for k∈[r], let Equation 1 (presented above) provide the sketches for each relation and

$$X = \frac{1}{m} {\sum }_{j = 0}^{m - 1} {\prod }_{k = 0}^{r - 1}$$

c_{k,j} the cardinality estimate of the query, then we have:

$$𝔼 [ X ] = {\sum }_{i ∈ {I}_{0} \times … \times {I}_{r - 1}}^{□} {F}_{0} ( i ) … {F}_{r - 1} ( i ) {\prod }_{\{ u , v \} ∈ E}^{□} 1 ( {i}_{u} = {i}_{v} ) Var ( X ) \leq \frac{1}{m} {3}^{r - 1} {\prod }_{k = 0}^{r - 1} {‖ {F}_{k} ‖}_{2}^{2}$$

From the perspective of the Count sketch extensions discussed above, this method can be interpreted as a similar generalization but for the AMS sketch.

### Other Related Work

In this section, we discuss other recent work in cardinality estimation. The Pessimistic Estimator is an interesting sketching technique which provides an upper bound of the cardinality. They show that it improves upon the cardinality estimator within PostgreSQL. However, the practical use of the method is limited due to its lengthy estimation time, at times exceeding the query execution time, as also mentioned by the authors.

Since the inception of sketching, a number of techniques have been proposed that complement the aforementioned sketches. Among these techniques, the Augmented Sketch and the JoinSketch aim to improve the accuracy of sketches for skewed data by separating the high-from the low-frequency items in the sketch. The counters of the high-frequency items are explicitly represented in an additional data structure, thereby preventing them from causing high estimation error due to hash collisions. Another notable technique is the Pyramid sketch, which employs a specialized data structure that dynamically adjusts the number of allocated bits for each counter, preventing overflows in the case of high-frequency items. It is important to note that these techniques are proposed as complementary tools, compatible with a variety of sketching methods, including the one proposed in this work.

Recently, there has been a parallel effort aimed at harnessing the power of machine learning for cardinality estimation. Among the various approaches, the most promising ones are data-driven methods that build query-independent models to estimate the joint probability of tuples. Notable examples of such techniques include DeepDB, BayesCard, NeuroCard, and FLAT. While machine learning-based cardinality estimation techniques have been receiving increasing attention, they still face important limitations: these methods are presently viable only in scenarios where supervised training is feasible, their accuracy has not consistently lived up to expectations, and they prove impractical in situations with frequent data updates, such as streaming settings, due to their high cost of model updates. In one of the following sections, we demonstrate that our proposed method not only avoids these performance limitations but also achieves significantly higher accuracy compared to the machine learning techniques.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Method

In this section, we present the method provided by the technology disclosed to solve the longstanding challenge of integrating the key advantages of the Count sketch, such as its efficient update mechanism and superior accuracy when handling skewed data, into a method that effectively estimates the cardinality of multi-join queries. Devising such a method is recognized as a challenging task, as underscored not only by the author of the Count-Min sketch but also by other recent work in the field. This acknowledgment highlights the importance of our contribution. The importance of solving this problem is further underscored when considering the prevalence of multi-join queries. In fact, an analysis of two sets of widely recognized benchmarking queries, as discussed in a following section, reveals that multi-joins constitute approximately 97% of all their queries.

### Implementation of the Technology Disclosed

The following sections disclose the details of the sketching technique disclosed herein including the pseudocode that implements the technology disclosed, in accordance with one implementation of the technology disclosed.

### Key Insight for Preserving Information

We start with an intuitive discussion on the main insight behind the proposed method, using the example illustrated in FIG. 5. The main challenge of combining the Count sketch with the method proposed by lies in the inability to effectively merge Count sketches using the Hadamard product. Existing techniques can create the sketch for a tuple as the Hadamard product of the AMS sketches for each value in the tuple. As discussed earlier, the advantages of the Count sketch stem from its sparsity. However, as illustrated in the left part of the figure, it is precisely this characteristic that results in a loss of information, with high probability, when combining sketches with the Hadamard product. Essentially, due to the sparsity, the non-zero entry in each sketch is highly likely to appear at a different position, causing the result of the element-wise multiplication to yield a zero vector, devoid of information.

To address this issue, the core concept behind our method, as depicted in the right part of FIG. 5, involves the utilization of circular convolution paired with circular cross-correlation (see Definitions 2 and 5) during inference. FIG. 5 presents a comparison of the Hadamard product (left-half of FIG. 5) and circular convolution (right-half of FIG. 5) on two single-item Count Sketches. The resulting sketch represents the 2-tuple (a, b). With circular convolution, the resulting sketch has the product of the non-zero entries in the bin that corresponds to the sum of the non-zero indices, modulo m. For example, as shown in FIG. 5, a product of “−1” (501) and “+1” (503) is stored at a bin index “0” (505). Unlike the Hadamard product, this operation guarantees that the information is preserved. We delve deeper into this intuition and formalize it in the subsequent sections. Crucially, the circular convolution of single-item Count sketches can be computed in O(1) time, with respect to the sketch size m. This means that the sketch of a stream can be updated in constant time for each arriving tuple, in contrast to the O(m) time required by the AMS sketch with the Hadamard product. As we show empirically in a following section, this translates to sketch updates that are orders of magnitude faster.

Definition 5 (Circular cross-correlation). The circular cross-correlation x*y of any two vectors x, y∈C^{m} is a vector with elements given by (x*y)ⱼ=Σᵢ₌₀^{m-1}xᵢy_{(j+i)modm} for all j∈[m], where xᵢ denotes the complex conjugate of xᵢ.

### General Formulation by Example

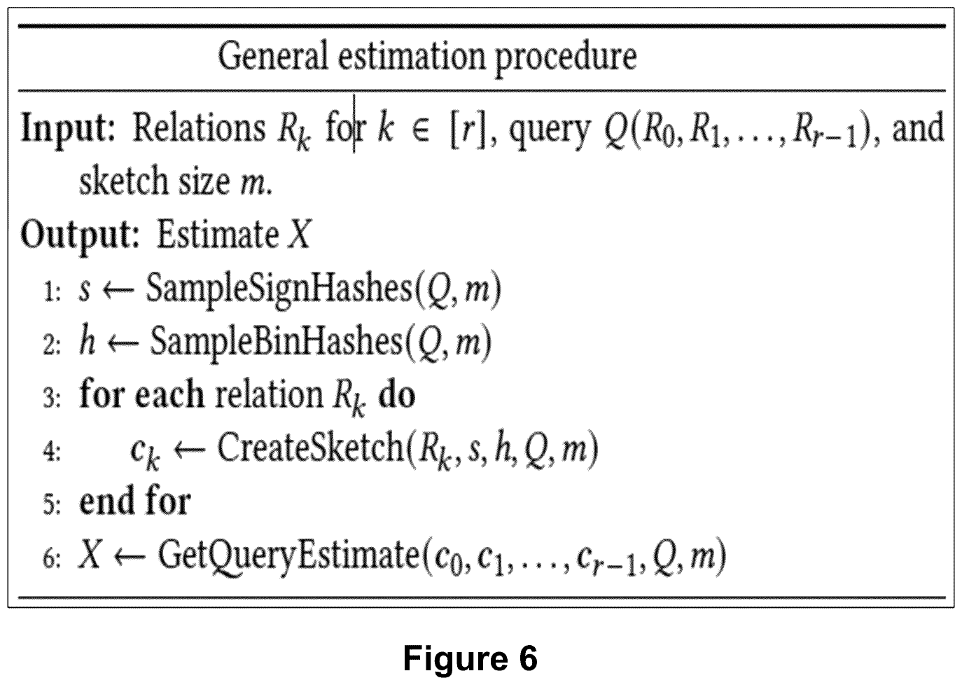

In order to facilitate a better understanding of the proposed method, we begin by demonstrating it through an illustrative example query. By showcasing the estimation process, we aim to provide valuable insights into the inner workings of our method. Following this, we formally present the method through its pseudocode. Furthermore, we prove that our method is an unbiased cardinality estimator for the previously defined family of multi-join queries and provide bounds on the estimation error. A general overview of our estimation procedure is provided in FIG. 6, labeled as “general estimation procedure”. In the following description, we shall use the example query from FIG. 4.

### Initialization

The proposed method starts by initializing the necessary hash functions and counters. We sample an independent random sign function s_{{u,v}}: [n]→{−1, +1}, drawn from a family of 4-wise independent hash functions for every join {u, v}∈E, represented by an edge in FIG. 4. Moreover, each graph component is assigned an independent random bin function h_{Ψ(u)}: [n]→[m], drawn from a family of 2-wise independent hash functions. Here, Ψ(u) represents the graph component to which attribute u belongs. A graph component comprises a set of attributes connected by joins, forming a subgraph that is not part of any larger connected subgraph. In the example, there are two graph components: {0,1,3} and {2,4}, identified by the labels 405 and 410, respectively in FIG. 4. A bin function is shared within a graph component because all the attributes that form a graph component must, by definition, be joined on equal values. Note that the equal values are mapped to the same bin by using the same bin function. Lastly, for each relation, a zero vector of m counters is initialized.

### Sketching

Once the counters and hash functions are initialized, the tuples from each relation stream are processed. When a tuple streams in, it is mapped to a single sign and bin, derived from the signs and bins of the joined attributes. To determine the sign of a tuple, all the signs of the joined attributes are multiplied together. For instance, tuple i from relation R₁ is hashed as follows: s_{{1,3}}(i₁)s_{{1,0}}(i₁)s_{{2,4}}(i₂), where iᵤ is the value for attribute u, and {u, v} denotes the join between attributes u and v. This is because R₁ has two joined attributes, and one of those is joined twice. Formally, the sign of a tuple i from relation Rₖ is given by Equation 2, below:

$${S}_{k} ( i ) = {\prod }_{u ∈ Ω ( {R}_{k} )}^{□} {\prod }_{v ∈ Γ ( u )}^{□} {s}_{\{ u , v \}} ( {i}_{u} )$$

To determine the bin of the tuple, the bin indices of all the joined attributes are summed, followed by taking the modulo m. Continuing our example, we have: (h_{Ψ(1)}(i₁)+h_{Ψ(2)}(i₂))modm because R₁ has two joined attributes. The bin index of a tuple i from relation Rₖ is formally given by Equation 3, below:

$$Hk ( i ) = ( {\sum }_{u ∈ Ω ( Rk )} h ψ ( u ) ( iu ) ) mod m$$

Subsequently, the sign of the tuple multiplied by the change of frequency is added to the counter at the bin index of the tuple.

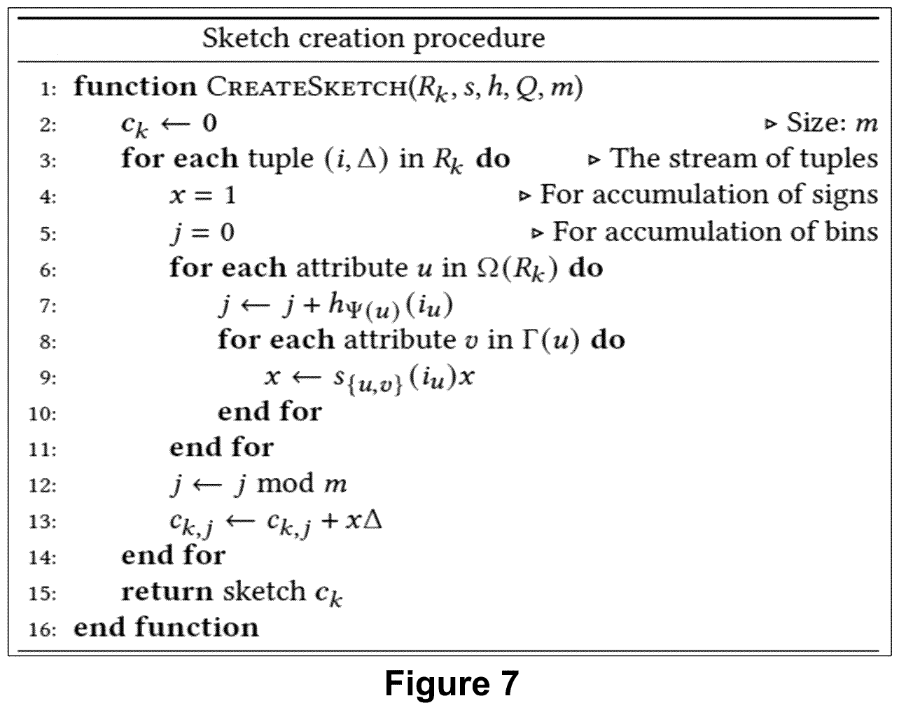

The sketching process for a tuple is equivalent to circular convolution between the sketches for each joined attribute value in the tuple. Since the individual sketches have only one non-zero value, the result of the circular convolution also has one non-zero value, which can be computed in constant time with respect to the sketch size, as explained earlier. The pseudocode for the general sketch creation procedure is provided in FIG. 7, labeled as “sketch creation procedure”. The sketch cₖ for relation Rₖ is formally stated as follows, in Equation 4, below:

$${c}_{k , j} = {\sum }_{i ∈ {I}_{k} : {H}_{k} ( i ) = j}^{□} {F}_{k} ( i ) {S}_{k} ( i )$$

where Fₖ(i) denotes the frequency of tuple i in relation Rₖ. The tuple i is from the domain Iₖ=[n]× . . . ×[n] of relation Rₖ.

### Inference

Upon creating the sketches for each relation, we can proceed to estimate the query's cardinality by combining sketches using either the Hadamard product or circular cross-correlation. The computation consists of summations over the sketch size for each graph component. The sketch for each relation is indexed by the sums of the graph components that have an attribute in that relation. Sketches of relations with multiple joined attributes will, therefore, also have multiple indices, and these are summed to obtain the final index. The sketch values inside the sums are all multiplied. An estimate of the example query is then obtained as follows: Σⱼ_{₀}₌₀^{m-1}Σⱼ_{₁}₌₀^{m-1}c_{0,j}_{₀}c_{2,j}_{₀}c_{1,(j}_{₀}₊ⱼ_{₁}_{)modm}c_{3,j}_{₁} because there are two graph components, and R₁ is part of both. This can be factorized as the Hadamard product between sketches c₀ and c₂ whose result is circular cross-correlated with c₁, followed by another Hadamard product with c₃, and lastly a summation over the elements. A cardinality estimate X is formally obtained using Equation 5 and Equation 6, as follows:

$$X = {\sum }_{j ∈ J}^{□} {\prod }_{k = 0}^{r - 1} {c}_{k , {G}_{k} ( j )}$$

$$Gk ( j ) = ( {\sum }_{u ∈ Ω ( Rk )} j ψ ( u ) ) mod m$$

where J is the cross product of bin domains [m]× . . . ×[m] for each graph component.

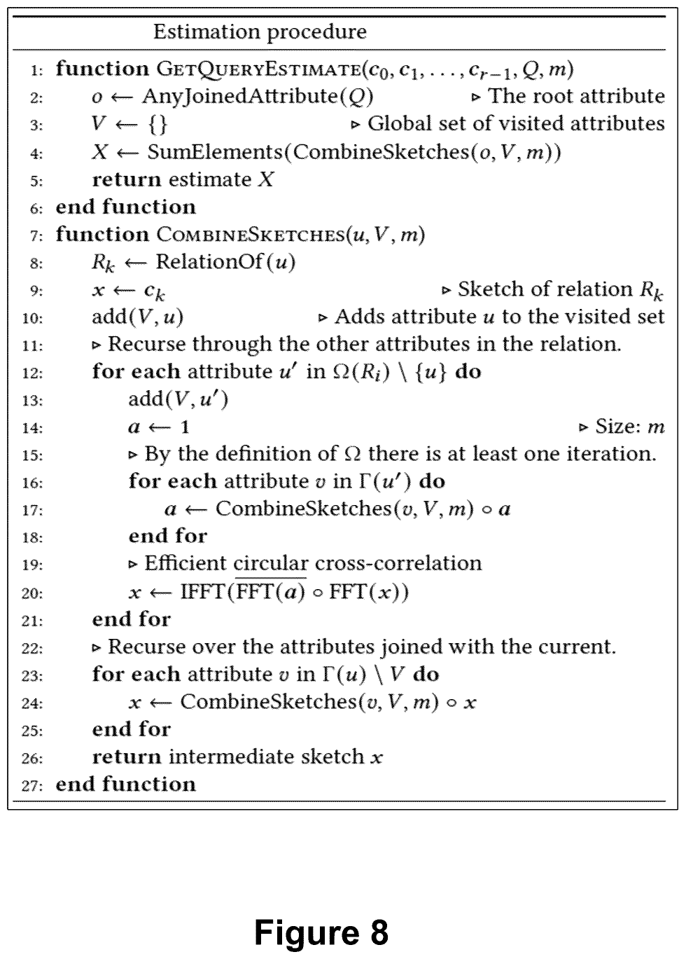

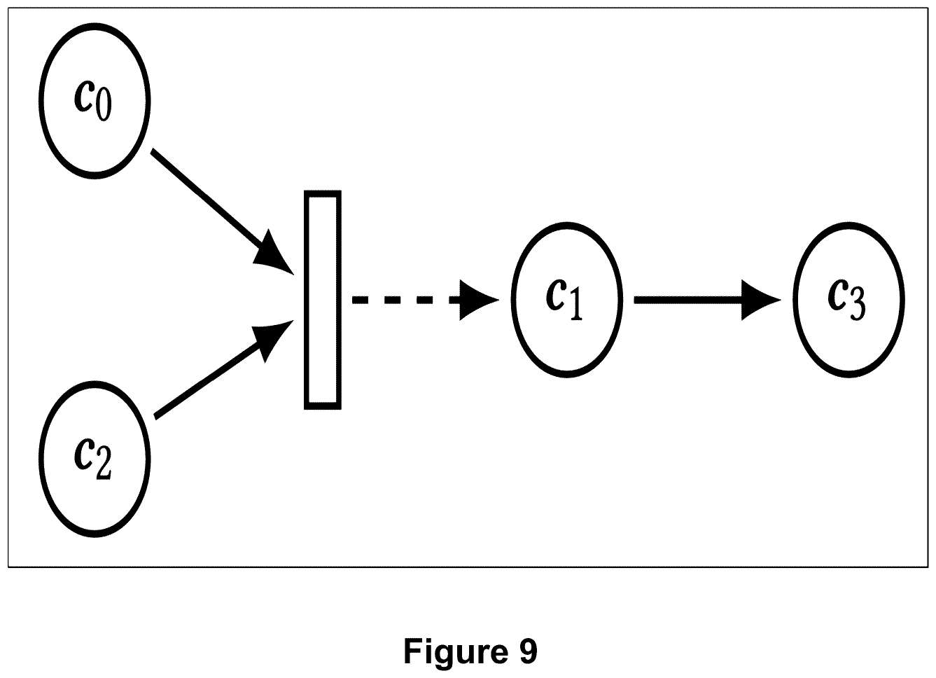

Computing the estimates using Equation 5 has an exponential time complexity with the number of graph components. However, this can be improved significantly by factorizing the problem. We can then rely on the fact that circular cross-correlation can be computed efficiently in O(m log m) time using the fast Fourier transform (FFT). To perform this efficient estimation process methodically, one starts by selecting any joined attribute, say attribute 4 in our example presented in FIG. 5. The process now aggregates all the sketches towards attribute 4 to obtain the estimate. This is implemented as a depth first traversal of the join graph with attribute 4 as the root node of a rooted tree and attributes 0 and 3 as the leaves. The general procedure for combining sketches to efficiently compute an estimate of the query is provided in in FIG. 8, labeled as “estimation procedure”. FIG. 9 presents the estimation process of the example query in FIG. 4 with attribute “4” (labeled as 415) as the root node. FIG. 9 presents the estimation process, where the circles denote the sketches of the relations and the vertical rectangle represents the Hadamard product identity. The solid and dashed arrows indicate the Hadamard product and circular cross-correlation, respectively. In the pseudocode, we ensure that the recursion only moves away from any selected root attribute o∈[w] by keeping track of the visited nodes V. The functions (I)FFT denote the (inverse) fast Fourier transform. This procedure reduces the inference time complexity to O(rm log m), that is, nearly linear with respect to the sketch size.

### Analysis

Now that we have discussed the estimation procedure, we present an analysis of the proposed method. We show that it is an unbiased estimator for the cardinality of multi-join queries in Theorem 4 (below), and provide guarantees on the estimation error. Lastly, we provide the time complexity for each estimation stage.
Theorem 4. Given an acyclic query of relations Rₖ for k∈[r], let Equation 4 provide the sketch for each relation and Equation 5 the cardinality estimate X of the query, then we have: [symbol] [X]=Σ_{i∈l}_{₀}_{× . . . ×l}_{ᵣ₋₁}^{□} F₀(i) . . . Fᵣ₋₁(i)Π_{{u,v}∈E}^{□}1(iᵤ=iᵥ);

$$Var ( X ) \leq \frac{1}{m} {3}^{r - 1} {\prod }_{k = 0}^{r - 1} {‖ {F}_{k} ‖}_{2}^{2}$$

Using the Chebyshev inequality and the upper bound on the variance from Theorem 4, we can bound the absolute estimation error by ∈>0 with m≥3^{r}∈⁻² Πₖ₌₀^{r-1}∥Fₖ∥₂². Furthermore, to guarantee the error with probability at most 1−δ, one selects the median of l=O(log 1/δ) i.i.d. estimates by the Chernoff bound. The exponential term 3^{r} indicates that accurately estimating queries involving many relations quickly becomes infeasible. It remains an open problem whether this exponential dependence can be improved. However, as we will show in the following section, for moderate sized queries, involving up to 6 relations, our estimation accuracy constitutes a significant improvement over the baselines.

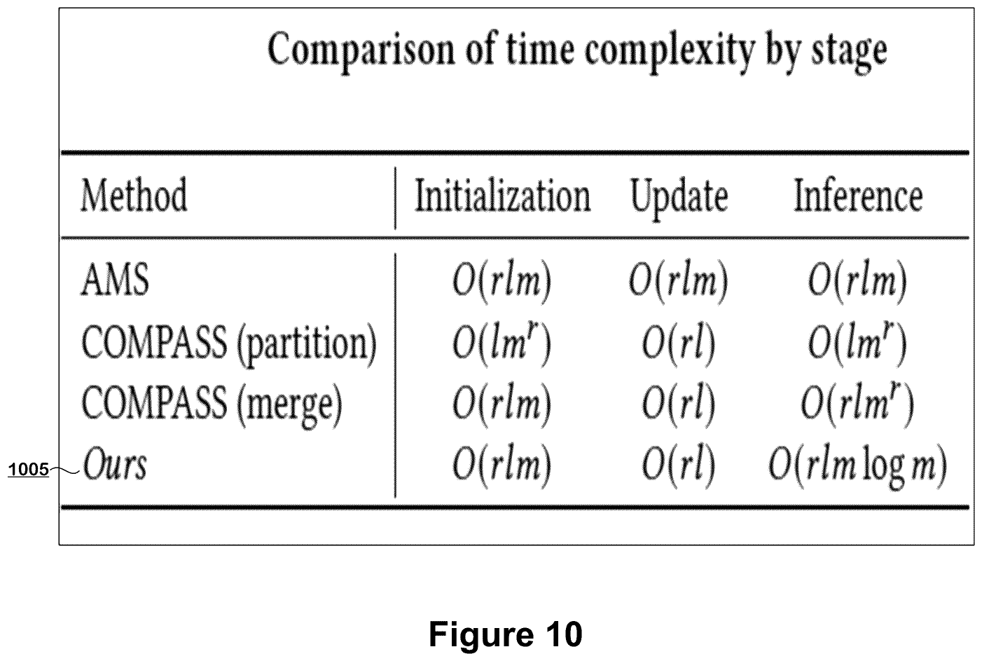

FIG. 10 presents a table, illustrating the time complexity of each estimation stage. The table compares the technology disclosed (identified by a label 1005) with the AMS-based technique by and the two variations of COMPASS (partition and merge). The symbols r, l, and m denote the number of relations, medians, and the sketch size, respectively. The update time of our method (as shown in the a row with a label 1005) for each incoming tuple is remarkably efficient, with a time complexity of only O(r log 1/δ). The efficient update time complexity, independent of the estimation error ∈, enables the sketching of high-throughput streams even when requiring a high level of accuracy. While COMPASS also has fast updates, its exponential dependence on r during inference limits its practical use even for moderately sized queries. Our method (1005) achieves fast updates yet introduces only an additional log m term during the inference stage, compared to the AMS baseline. This slight increase in inference time is negligible when considering the substantial improvement in update time. For instance, our experiments go up to m=10⁶ with l=5, which means that our method achieves roughly 10⁶ times faster sketch updates, while having only log₂(10⁶)≈20 times slower inference. As a result, our method (1005) effectively minimizes the overall estimation time in various crucial scenarios. These claims are further supported by our empirical results, which are presented in the following section.

Integration with Query Optimizers

The quintessential application of our proposed method is the cardinality estimator within query optimizers. Query optimizers use a plan enumeration algorithm to find a good join order. The cost of a join order dependents upon the sizes of the intermediate results. The cardinality estimator's role is to provide the estimates for these intermediate sizes. Each intermediate cardinality can be expressed as a sub-query which our method can estimate. The sketches for all the evaluated sub-queries can be created in a single pass over the data. Typically, each sub-query requires its own sketches; however, in cases where an attribute is joined multiple times, the sketches can be reused for each join involving that attribute. For example, to decide the join order of joins {0,1} and {1,3} in FIG. 4, the sketch for attribute “1” can be reused for attributes “0” and “3”. In the following section, we demonstrate the improvement in query execution time after integrating our proposed cardinality estimator into the query optimizer of PostgreSQL.

### Experiments

In this section, we conduct an empirical analysis to evaluate the effectiveness of our estimator and compare it to various baseline approaches. These baselines include the AMS-based method proposed by and the two variations of COMPASS, namely partition and merge. Our primary objective is to assess the accuracy of our estimator against the baselines for a specified memory budget. Furthermore, we compare the initialization, sketching, and inference times of our method with those of the baselines. Secondly, we compare the estimation error and execution time of our method with the four data-driven machine learning techniques discussed above: DeepDB, BayesCard, NeuroCard, and FLAT. Finally, we evaluate the impact of our cardinality estimator on the query execution time of PostgreSQL.

We implemented both the sketching baselines and our method using the PyTorch tensor library. The hash functions are implemented using efficient random polynomials over a Mersenne prime field. All experiments were conducted on an internal cluster of Intel Xeon Gold 6148 CPUs. Each experiment utilized a single CPU and 24 GB of memory..

### Databases and Queries

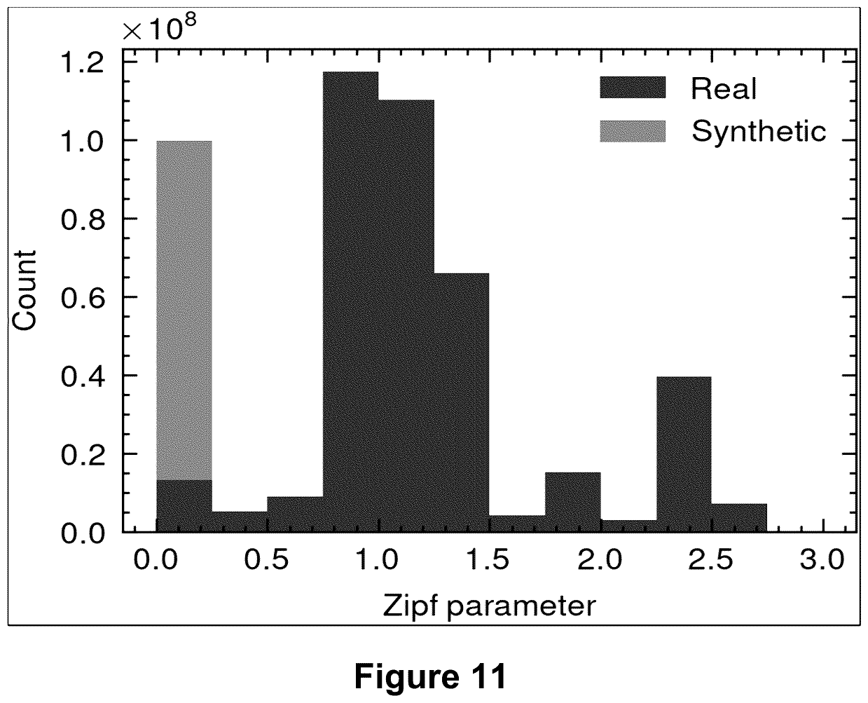

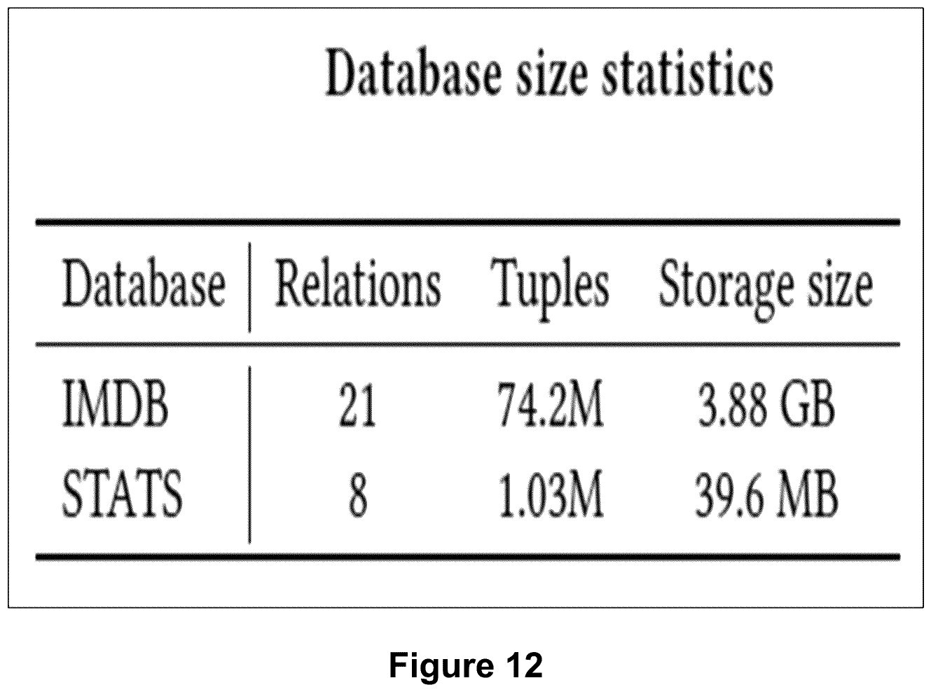

The limitations of synthetic databases in accurately reflecting real-world performance have been widely acknowledged in the literature. To address this concern, our experiments were conducted using two established benchmarking databases containing real data: the IMDB database, which encompasses information on movies, actors, and their associated production companies, and the STATS database, which comprises user-contributed content from the Stats Stack Exchange network. To provide insights into the characteristics of the databases, a table in FIG. 12 presents statistics detailing their respective sizes. Additionally, a graphical illustration in FIG. 11 presents the distribution skewness of the database entries, highlighting the significant skewness often observed in real data. Our experimentation covers all the 146 STATS-CEB and 70 JOB-light queries, in addition to the 3299 associated sub-queries from the cardinality estimation benchmark. These queries collectively represent a diverse range of real-world workloads. FIG. 11 presents a total number of entries across all columns of both the STATS and IMDB databases, grouped by the best fit Zipf parameter of each column. Synthetic entries refer to the “id” and “md5sum” columns, which are unique by design, the real entries include all other columns.

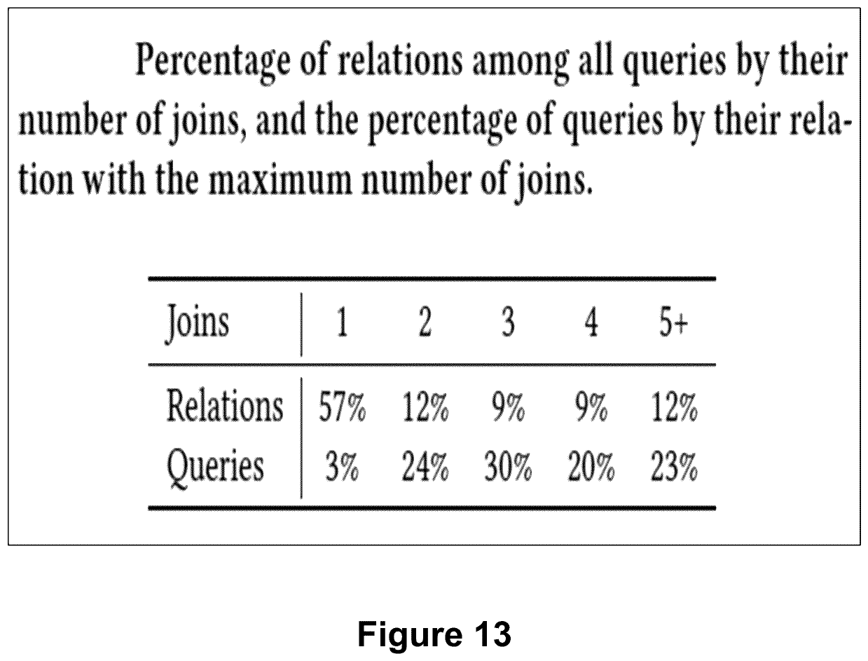

A key feature of our proposed method is its ability to efficiently estimate multi-join queries. As previously mentioned, our motivation for this capability is rooted in the prevalence of such queries in real-world scenarios. To further substantiate this motivation, we conducted an analysis of all the queries in both the cardinality estimation benchmark and the join order benchmark. The results, displayed in a table in FIG. 13, indicate that 44% of the relations in the queries are involved in multiple joins, with single joins being the most common at 57%. Notably, 97% of the queries contain at least one relation which participates in multiple joins. These statistics underscore the significance of supporting multi-join queries to effectively address the majority of real-world query scenarios. FIG. 13 presents percentage of relations among all queries by their number of joins, and the percentage of queries by their relation with the maximum number of joins.

In the experiments the filter predicates of each query are processed during ingestion of the tuples from their respective relation streams. In many streaming algorithms, the query is assumed to be known in advance of the stream. Consequently, filtering the tuples at the time of ingestion offers advantages in terms of performance and accuracy. This approach eliminates the need to update the sketch for tuples that do not satisfy the filters. In addition, the estimation accuracy is significantly improved as some data is already filtered out from the sketches. However, it is worth mentioning that sketching methods, including the one presented, are also capable of handling filter predicates during inference. This can be achieved by treating the filters as joins with imaginary tables. Lastly, in our experiments, we report the median of l=5 i.i.d. estimates as the cardinality estimate for all sketching methods.

### Estimation Accuracy

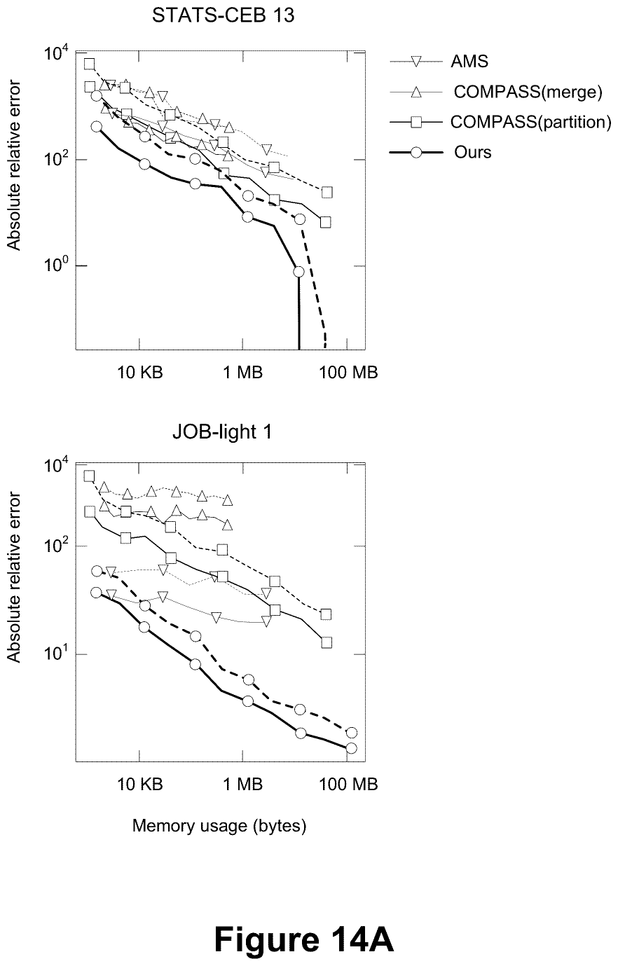

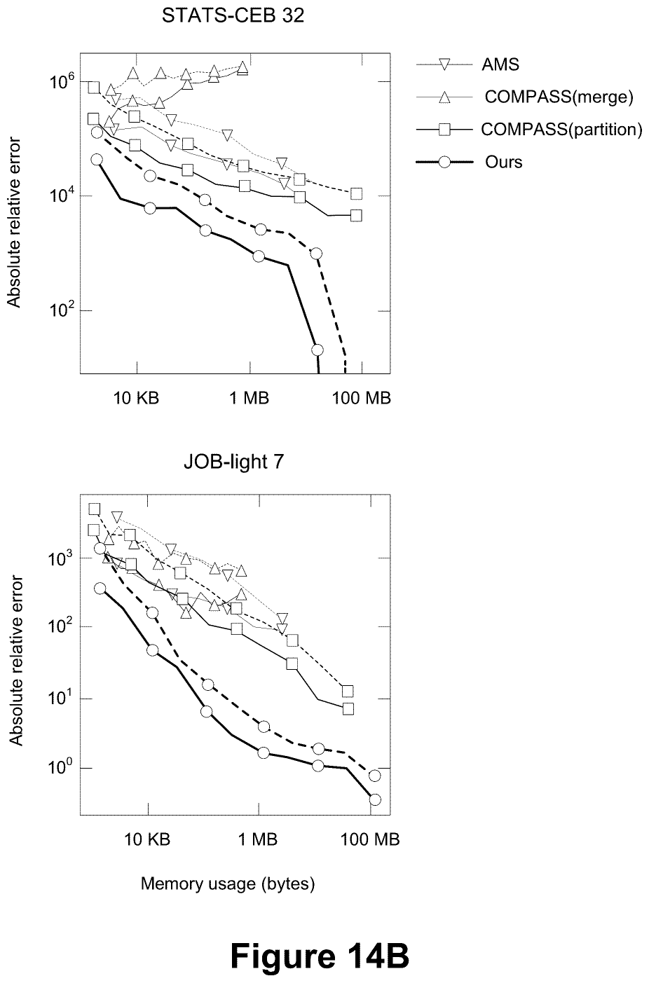

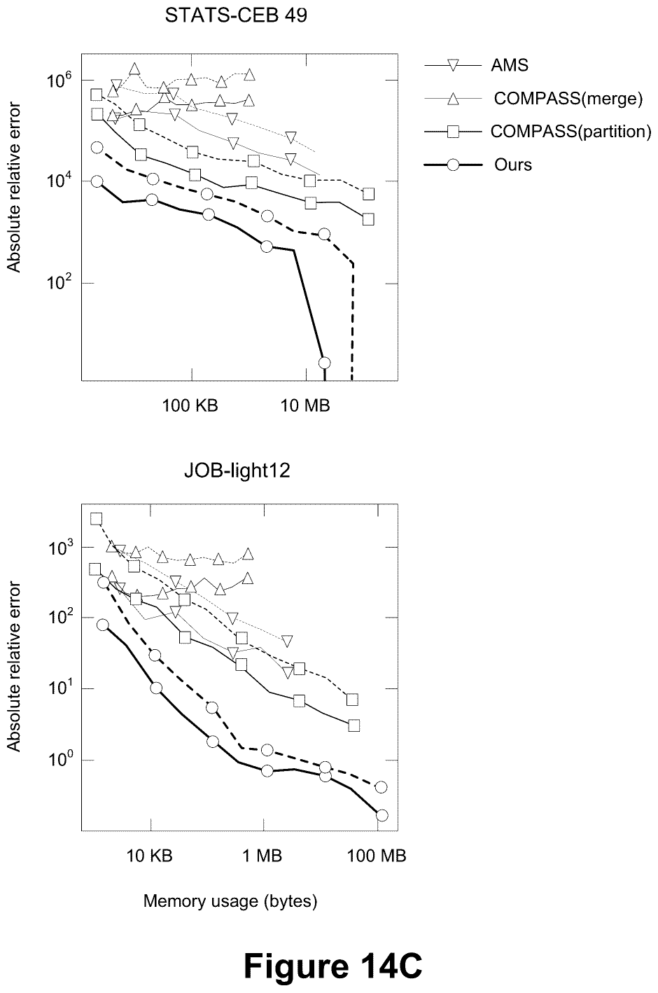

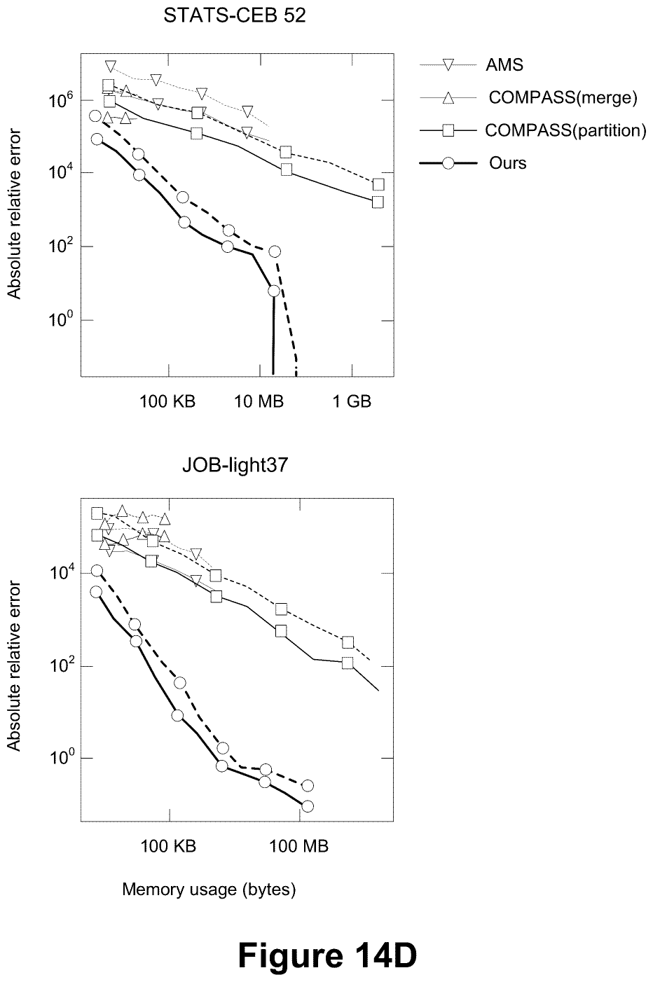

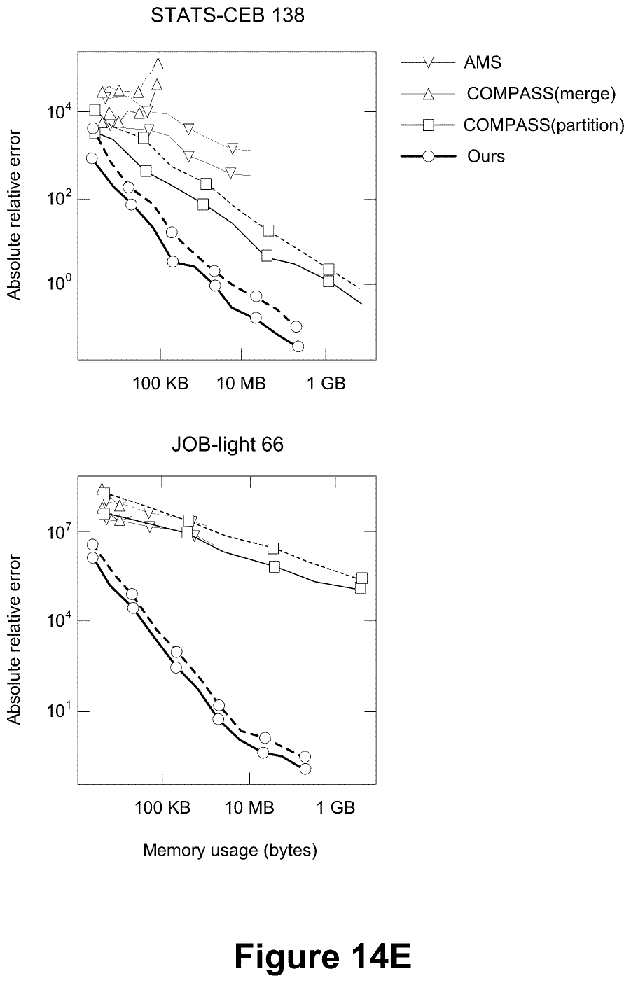

We first compare the estimation accuracy of the different sketching methods in terms of the absolute relative error, defined as y−ŷ∨ divided by max(y, 1), where y is the true cardinality and ŷ its estimate. This metric aligns with the formulation of the theoretical error bound outlined above. In FIGS. 14A, 14B, 14C, 14D and 14E, we present the median and the 95th percentile of the error at varying sketch sizes. The statistics are derived from 30 repetitions, each with distinct random initializations. The results are presented for a representative subset of the queries, necessitated by space constraints. In FIGS. 14A to 14E, the absolute relative error of our method compared to the baselines at varying sketch sizes is presented. Solid lines in graphs in FIGS. 14A to 14E represent the median error and dashed lines denote the 95th percentile. The memory usage includes the counters of the sketches and the random seeds for the hash functions, but excludes the space needed for the intermediate inference calculations. The lines in graphs with circles represent the result for the technology disclosed (labeled as “ours”) in the legend on graphs in FIGS. 14A to 14E. Results for other techniques (AMS, COMPASS-merge, COMPASS-partition) are labeled with other geometrical shapes as indicated in the legend on graphs in FIGS. 14A to 14E.

It is important to note that the experiments for AMS and COMPASS (merge) do not extend to the highest memory usage levels. This limitation arises due to the extensive time required to run the AMS-based experiments, which increases exponentially with each additional data point, rendering their execution quickly infeasible. Additionally, COMPASS (merge) encountered memory constraints during the inference stage, as its memory demand grows exponentially with the number of joins. Notice that the depicted memory usage excludes intermediate representations during inference, thus understating the actual memory required for COMPASS (merge).

Upon analyzing the results, we observe that the proposed method delivers comparable or lower error rates across all queries, often demonstrating orders of magnitude greater accuracy. The proposed method achieves zero error on many queries with large sketches. In realistic sketching applications, a margin of error is acceptable; therefore, sketches ranging from 1 to 10 MB could be employed for the STATS-CEB and JOB-light queries. For certain queries, like JOB-light 37 and 66, our method not only achieves significantly lower error but also demonstrates a more rapid reduction in error with each increase in memory.

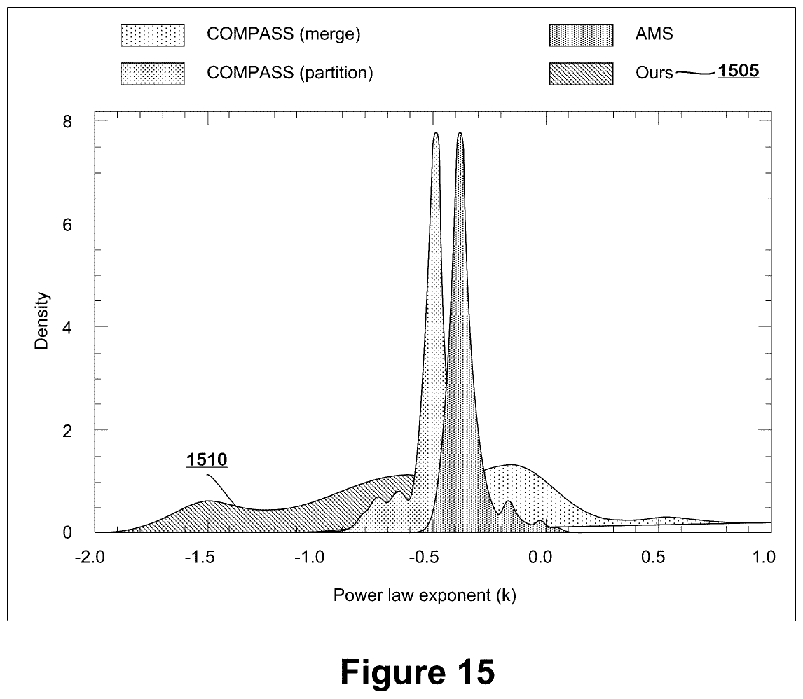

To assess the rate at which our method improves the estimation error compared to the baselines, FIG. 15 presents kernel density estimates of the slopes derived from the absolute relative error results for all 216 queries. These slopes are obtained by least-squares linear regression of the data for each method and query in log-log space. This means that the slope represents the exponent of a power law relationship, where the error at memory usage m is given by am^{k}, with k as the slope and a as the error at m=1. A higher concentration on the left signifies a greater improvement in accuracy as the memory budget increases. The results for the technology disclosed are labeled as 1505 (ours) in the legend and are visible in the graph as indicated by a label 1510.

Our method exhibits a significantly faster reduction in error, highlighting its ability to achieve high accuracy with substantially less memory compared to the baselines. Considering that the real data in our experiments is skewed, as indicated in FIG. 11, we can state that our method successfully inherits and expands upon the advantages associated with the Count sketch, particularly its effectiveness in handling skewed data. In the context of multi-joins, our method capitalizes on these benefits, demonstrating its ability to compute accurate cardinality estimates.

### Execution Times

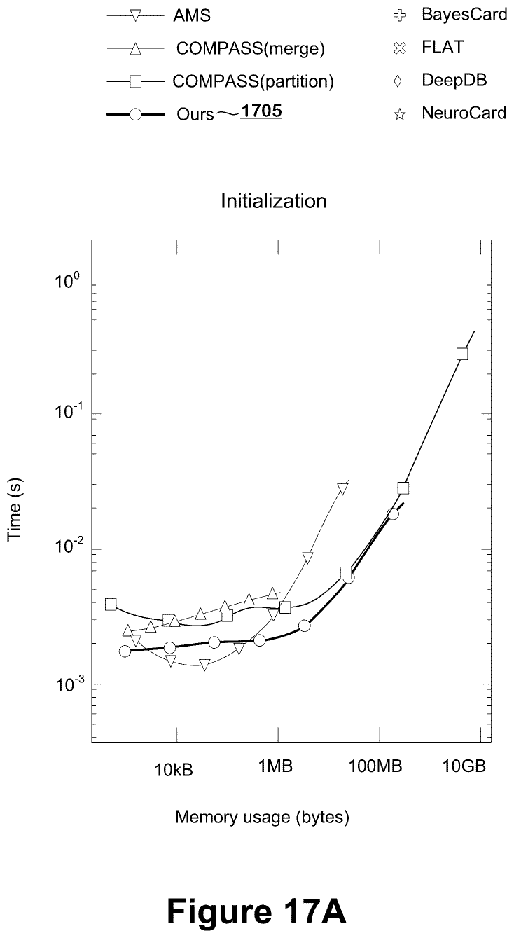

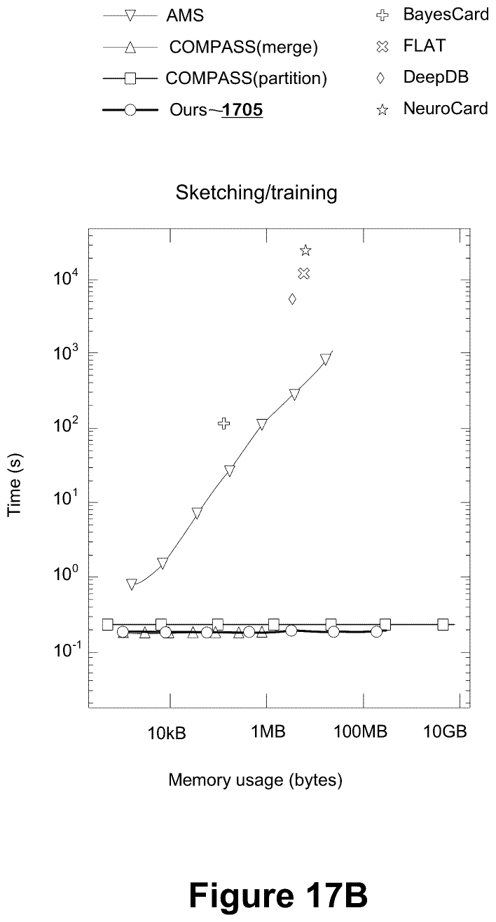

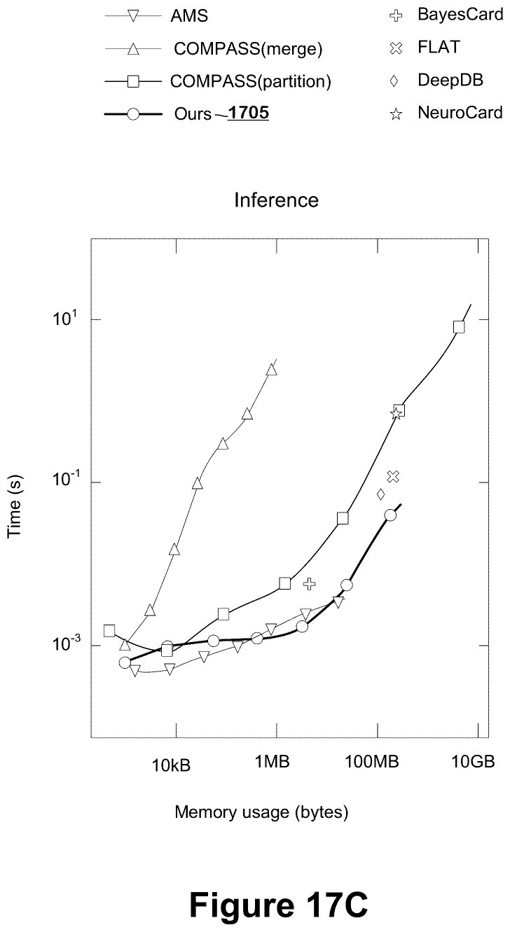

In the second set of experiments, we look into the execution time of our method and how it compares to the baselines across varying sketch sizes. In FIGS. 17A, 17B and 17C, we present the execution times for each stage of the estimation process: initialization, sketching, and inference. The graphs in FIGS. 17A, 17B and 17C show the best fit of a Gaussian process regression to the experimental results from all queries, totaling 232,323 experiments. It also contains data for the learning-based methods which will be discussed in the following section. The graphs in FIGS. 17A, 17B and 17C present execution times for the three stages (initialization, sketching/training, and inference) of the baselines and our method at varying sketch/model sizes. The plots show the best fit of a Gaussian process regression of the data in log-log space, along with standard deviation. The memory usage includes the counters of the sketches and the random seeds for the hash functions. The data for BayesCard, FLAT, DeepDB, and NeuroCard is obtained from Han et. al., “Cardinality estimation in DBMS: a comprehensive benchmark evaluation,” published in proceedings of VLDB Endowment 15, 4 (2021), pp. 752-765. The results for the technology disclosed are indicated using lines with circles (as shown in the legend) and identified by a label 1705 on FIGS. 17A, 17B and 17C.

While the initialization time exhibits a similar trend for all methods, in sketching time there is a notable disparity between AMS and the other methods. This disparity directly reflects the difference in update time complexity. The methods also differ in initialization time complexity, but this is not visible in the timing results because they are plotted with respect to their memory usage rather than the sketch size. That is, for a given sketch size COMPASS (partition) allocates more memory, but for a given memory budget, all methods have similar initialization time. Among the inference times, our method demonstrates remarkable overall efficiency. Even for the most complex queries with the largest sketch size, our method computes its estimate within ten seconds. In contrast, the AMS-based method requires hours to compute estimates, with the majority of that time spent on sketching, all while delivering higher error rates.

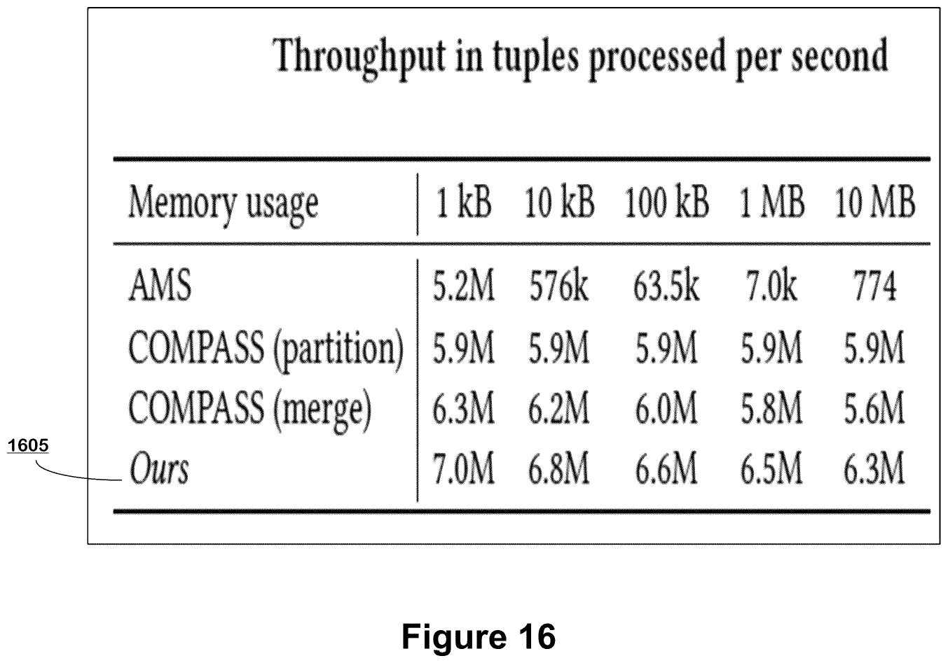

To further validate the fast update time of our method, we assessed the maximum stream throughput for all baselines, as outlined in a table presented in FIG. 16. The memory usage includes the counters of the sketches and the random seeds for the hash functions. The results were obtained by performing linear least-squares regression on the throughput measurements for each method on all queries. For smaller sketch sizes, the AMS-based method can achieve a throughput similar to the Count sketch-based approaches. However, when working with larger sketch sizes required for high estimation accuracy, the AMS-based method becomes limited to handling just a few hundred tuples per second. This significant limitation severely restricts the practical usability of AMS in streaming scenarios.

Comparison with Learning-Based Methods

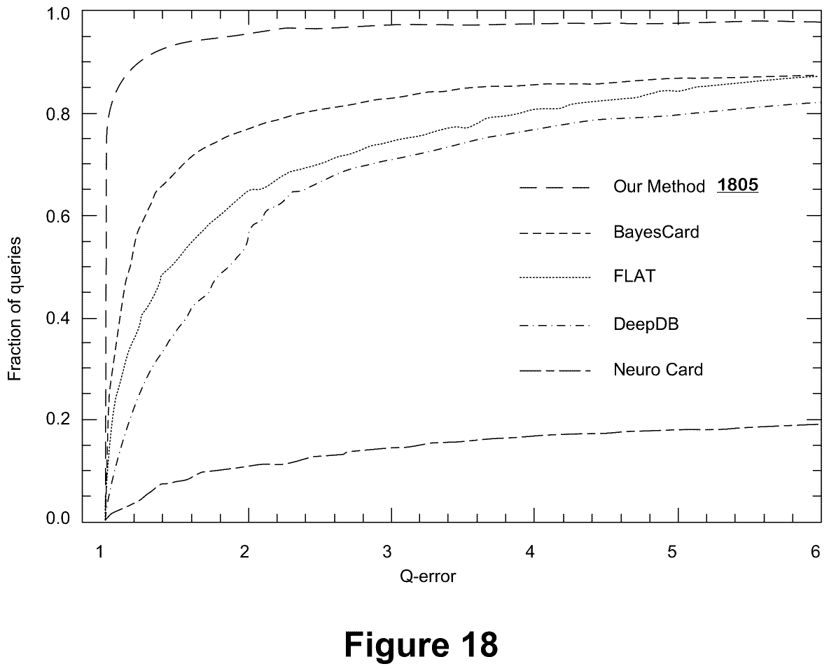

In a further set of experiments, we compare the cardinality estimation performance of our proposed method with the four data-driven machine learning techniques discussed in above. Specifically, we compare their execution time and estimation quality. To evaluate the quality of cardinality estimates, we employ the q-error metric, defined as max(y/ŷ, ŷ/y) if ŷ>0 and ∞ otherwise. FIG. 18 presents the cumulative distribution function of the q-error for all 3299 sub-queries, showing the fraction of queries that were estimated within a certain q-error. Our method (1805) was configured with m=1,000,000 bins, resulting in an average estimation time of 0.30 seconds and consuming an average of 137 MB of memory. To maintain consistency with the results of the learning methods, as obtained from the cardinality estimation benchmark, our method estimated the cardinality of each sub-query only once. FIG. 18 presents cumulative distribution function of the q-error for the STATS-CEB and JOB-light sub-queries. The legend follows the ordering of the lines in the figure with the line at the top corresponding to the method (1805) disclosed herein.

The results presented in FIG. 18 highlight the superior performance of the proposed method (as compared to other techniques), which delivers error-free estimates for approximately 70% of the sub-queries. Furthermore, our method achieves q-error values of less than 2 for about 95% of the sub-queries. In contrast, even the best-performing learning-based method, BayesCard, achieves this level of accuracy for less than 80% of the sub-queries. These findings demonstrate the remarkable estimation accuracy of our proposed estimator. Moreover, our sketching approach provides theoretical guarantees on the estimation error which are lacking for the learning-based methods.

Our proposed method is also notably efficient when compared to the learning-based methods. As depicted in FIGS. 17A, 17B and 17C, the training phase of the learning-based methods requires 3 to 5 orders of magnitude more time than creating our sketches. In addition, a table in FIG. 16 shows that our method can handle over 6 million updates per second (identified in the table row labeled as 1605). This is because our method simply adds another item to the sketch. BayesCard, on the other hand, takes 12 seconds to process an update, and the other learning-based methods take several minutes. Consequently, these learning-based methods prove impractical for scenarios involving frequent updates.

### PostgreSQL Query Execution Time

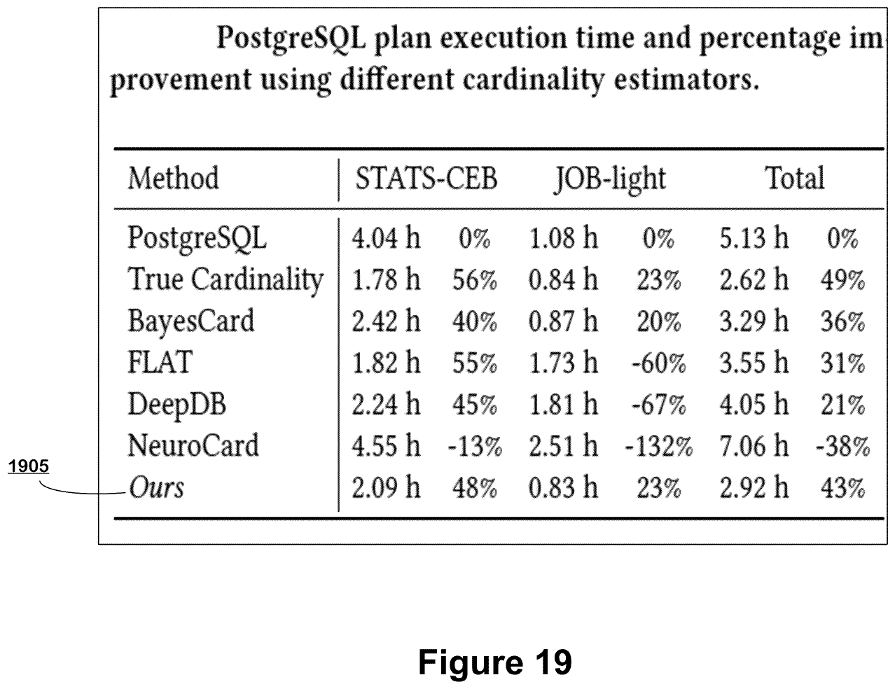

In the last set of experiments, we evaluate the impact of our cardinality estimator on the query execution time of PostgreSQL. We utilized the evaluation setup and modified PostgreSQL to enable the injection of cardinality estimates for all the sub-queries of the STATS-CEB and JOB-light queries. We compare our method against PostgreSQL's own cardinality estimator as well as the aforementioned learning-based methods. FIG. 19 presents a table that shows the total execution time for all the queries. The injected sub-query cardinality estimates are those reported above. The table in FIG. 19 presents PostgreSQL plan execution time and percentage improvement using different cardinality estimators (i.e., other cardinality estimation methods or techniques). In the results, PostgreSQL refers to the default PostgreSQL cardinality estimator, and True Cardinality denotes an oracle method with access to the actual intermediate sizes. The results for the method provided by the technology disclosed are presented in the table row labeled as 1905 in the table in FIG. 19.

As shown in FIG. 19, our proposed method achieved the lowest total execution time with an improvement of 43% compared to PostgreSQL. On STATS-CEB, our method improves over PostgreSQL by 48%, falling just short of FLAT, which showed an improvement of 55%. On JOB-light, our method achieved equivalent execution time to the True Cardinality, while most other learning-based methods, with the exception of BayesCard, do not improve over PostgreSQL. These results underscore the practical advancement enabled by our proposed method due to its superior estimation accuracy, in addition to its exceptional efficiency.

### CONCLUSION

The technology disclosed provides a new sketching method that significantly enhances the cardinality estimation for multi-join queries. The proposed approach provides fast update times, which remain constant irrespective of the required estimation accuracy. This crucial feature allows for efficient processing of high-throughput streams, all the while delivering superior estimation accuracy compared to state-of-the-art baseline approaches. This is substantiated by our bound on the estimation error, as well as our empirical findings. Our results underscore the practical suitability of the proposed method for applications such as query optimization and approximate query processing, surpassing the capabilities of previous methods. The presented method successfully addresses the longstanding challenge of integrating the key advantages of the Count sketch with the AMS-based method for multi-join queries.

### Mean and Variance

In this section, we present the proofs for Theorems 3 and 4.

Proof for Theorem 3. By the definitions of X and c_{k,j}, with I=I₀× . . . ×Iᵣ₋₁, and using the linearity of expectation, we get:

$$𝔼 [ X ] = \frac{1}{m} {\sum }_{j = 0}^{m - 1} {\sum }_{i ∈ I}^{□} 𝔼 [ ] {\prod }_{k = 0}^{r - 1} {F}_{k} ( i ) {\prod }_{u ∈ Ω ( {R}_{k} )} {\prod }_{v ∈ Γ ( u )} {s}_{j , \{ u , v \}} ( {i}_{u} )$$

By construction of the sketches, the sign functions are independent across different joins and there are exactly two occurrences of each sign function, one for each end of a join edge. We can thus write:

$$𝔼 [ X ] = \frac{1}{m} {\sum }_{j = 0}^{m - 1} {\sum }_{i ∈ I}^{□} ( ) {\prod }_{k = 0}^{r - 1} {F}_{k} ( i ) {\prod }_{\{ u , v \} ∈ E} 𝔼 [ {s}_{j , \{ u , v \}} ( {i}_{u} ) {s}_{j , \{ u , v \}} ( {i}_{v} ) ]$$

Since [symbol] [s(a)s(b)]=1(a=b), we get the desired expectation.

For the variance, all the dimensions of the sketches are i.i.d., and since Var(X)= [symbol] [X²]− [symbol] [X]², for any j∈[m], we have:

$$Var ( X ) = \frac{1}{m} Var ( {\prod }_{k = 0}^{r - 1} {c}_{k , j} ) \leq \frac{1}{m} E [ {( {\prod }_{k = 0}^{r - 1} {c}_{k , j} )}^{2} ]$$

By the definition of c_{k,j} and the linearity of expectation, we have:

$$Var ( X ) \leq \frac{1}{m} {\sum }_{i ∈ I}^{□} {\sum }_{i ′ ∈ I}^{□} {F}_{0} ( i ) ⋯ {F}_{r - 1} ( i ) {F}_{0} ( {i}^{′} ) ⋯ {F}_{r - 1} ( {i}^{′} ) 𝔼 [ {\prod }_{k = 0}^{r - 1} {\prod }_{u ∈ Ω ( {R}_{k} )}^{□} {\prod }_{v ∈ Γ ( u )}^{□} {s}_{j , \{ u , v \}} ( {i}_{u} ) {s}_{j , \{ u , v \}} ( {i}_{u}^{′} ) ]$$

Taking into account that each sign function occurs twice (now four times since the value is squared), we obtain:

$$Var ( X ) \leq \frac{1}{m} {\sum }_{i ∈ I}^{□} {\sum }_{i ′ ∈ I}^{□} {F}_{0} ( i ) ⋯ {F}_{r - 1} ( i ) {F}_{0} ( {i}^{′} ) ⋯ {F}_{r - 1} ( {i}^{′} ) {\prod }_{\{ u , v \} ∈ E}^{□} 𝔼 [ {s}_{j , \{ u , v \}} ( {i}_{u} ) {s}_{j , \{ u , v \}} ( {i}_{u}^{′} ) {s}_{j , \{ u , v \}} ( {i}_{v} ) {s}_{j , \{ u , v \}} ( {i}_{v}^{′} ) ]$$

By the four-wise independence of the sign functions, the expected value is one if there are two equal pairs or if all values are equal, and zero otherwise. Therefore, we have that:

$$𝔼 [ {s}_{j , \{ u , v \}} ( {i}_{u} ) {s}_{j , \{ u , v \}} ( {i}_{u}^{′} ) {s}_{j , \{ u , v \}} ( {i}_{v} ) {s}_{j , \{ u , v \}} ( {i}_{v}^{′} ) ] = 1 ( ( {i}_{u} = {i}_{v} ⋀ {i}_{u}^{′} = {i}_{v}^{′} ) ⋁ ( {i}_{u} = {i}_{u}^{′} \neq {i}_{v} = {i}_{v}^{′} ) ⋁ ( {i}_{u} = {i}_{v}^{′} \neq {i}_{v} = {i}_{u}^{′} ) )$$

For each join, there are three disjunctions which are conjoined over all the joins. By the distributivity property of conjunction over disjunction, there are thus 3^{E∨} disjunctions in total. Since the queries are acyclic, E∨r−1. The variance is bound by the sum over all disjunctions, where intersections are counted double. Using the Cauchy-Schwarz inequality, each disjunction itself is bound by the product of squared frequency norms. This gives the desired upper bound on the variance. □

Proof for Theorem 4. By the definitions of X and Sₖ, with I=I₀× . . . ×Iᵣ₋₁, and the linearity of expectation, we have:

$$𝔼 [ X ] = {\sum }_{j ∈ J}^{□} {\sum }_{i ∈ I}^{□} {F}_{0} ( i ) ⋯ {F}_{r - 1} ( i ) 𝔼 [ {\prod }_{k = 0}^{r - 1} 1 ( ) {H}_{k} ( i ) = {G}_{k} ( j ) {\prod }_{u ∈ Ω ( {R}_{k} )}^{□} {\prod }_{v ∈ Γ ( u )}^{□} {s}_{\{ u , v \}} ( {i}_{u} ) ]$$

By the definitions of Hₖ and Gₖ, since the sign and bin functions are independent, and using again the observation that each sign function occurs twice, we can write:

$$𝔼 [ X ] = {\sum }_{i ∈ I}^{□} {F}_{0} ( i ) ⋯ {F}_{r - 1} ( i ) ( ) {\prod }_{\{ u , v \} ∈ E}^{□} 1 ( {i}_{u} = {i}_{v} ) {\sum }_{j ∈ J}^{□} 𝔼 [ ] {\prod }_{k = 0}^{r - 1} 1 ( ) {\sum }_{u ∈ Ω ( {R}_{k} )}^{□} {h}_{Ψ ( u )} ( {i}_{u} ) - {j}_{Ψ ( u )} ≡ 0 ( mod m )$$

By isolating the case where all iᵤ=iᵥ, all the attribute values in the same graph component must be equal. Since each independent bin function is thus called with only one distinct value, the expected value of the bin functions is m^{-(w-r+1)}, which is exactly the reciprocal of J∨, giving the desired expectation.

For the variance, we have that Var(X)= [symbol] [X²]− [symbol] , where:

$${E [ X ]}^{2} = Σi ∈ I Σ {i}^{′} ∈ {I}^{′} [ \prod k = 0 ) r - 1 ) {F}_{k} ( i ) {F}_{k} ( {i}^{′} ) ] \prod u , ω ∈ E 1 ( iu = i ω ⋀ {iu}^{′} = i {ω}^{′} )$$

$${E [ X ]}^{2} = Σi ∈ I Σ {i}^{′} ∈ {I}^{′} [ \prod k = 0 ) r - 1 ) {F}_{k} ( i ) {F}_{k} ( {i}^{′} ) ] ( \prod u , ω ∈ E E [ su , ω 1 ( iu = i ω ) su , ω ( i ) su , ω ( {i}^{′} ) ] )$$

$$Σ j ∈ J Σ {j}^{′} ∈ {J}^{′} E [ 1 ( {H}_{k} ( i ) = {G}_{k} ( j ) ) 1 ( {H}_{k} ( {i}^{′} ) = {G}_{k} ( {j}^{′} ) ) ]$$

The expected value of the sign functions is stated in the proof for Theorem 3. If we consider only the first disjunction, then we get:

$${E [ X ]}^{2} Σ j ∈ J Σ {j}^{′} ∈ {J}^{′} E [ Π k = 0 ) r - 1 ) 1 ( {H}_{k} ( i ) = {G}_{k} ( j ) ) 1 ( {H}_{k} ( {i}^{′} ) = {G}_{k} ( {j}^{′} ) ) ]$$

Which is equal to [symbol] , because when iᵤ=iᵥ∧i′ᵤ=i′ᵥ, all graph components must have one or two distinct values each. In the case of one distinct value, j_{q}=j′_{q} for that graph component q. Thus, the expected value per graph component is either 1/m² or 1 (j_{q}=j′_{q})/m, making the sums over J equal to 1. Now, let us consider everything but [symbol] in [symbol] [X²]. There must be at least one occurrence of either iᵤ=i′ᵤ≠iᵥ=i′ᵥ or iᵤ=i′ᵥ≠iᵥ=i′ᵤ. Either way, j_{q}=j′_{q} for that graph component q while there are still at least two distinct values. The sums over J is thus ≤1/m. We then get that:

$${E [ X ]}^{2} = {E [ X ]}^{2} + Y ⇒ Var ( X ) \leq ( 1 / m ) {E [ X ]}^{2} + Y$$

$$Var ( X ) \leq ( 1 / m ) Σ i ∈ I Σ {i}^{′} ∈ {I}^{′} {F}_{0} ( i ) ⋯ Fr - 1 ( i ) {F}_{0} ( {i}^{′} ) ⋯ Fr - 1 ( {i}^{′} )$$

$$\prod u , v ∈ E 1 ( iu = iv ⋀ {iu}^{′} = {iv}^{′} ) + 1 ( iu = {iu}^{′} \neq iv = {iv}^{′} ) + 1 ( iu = {iu}^{′} \neq iv = {iv}^{′} )$$

Which is the same expression of the variance bound as the one for Theorem 3. The final steps of the variance bound are thus equivalent, resulting in the desired upper bound.

### Computer System

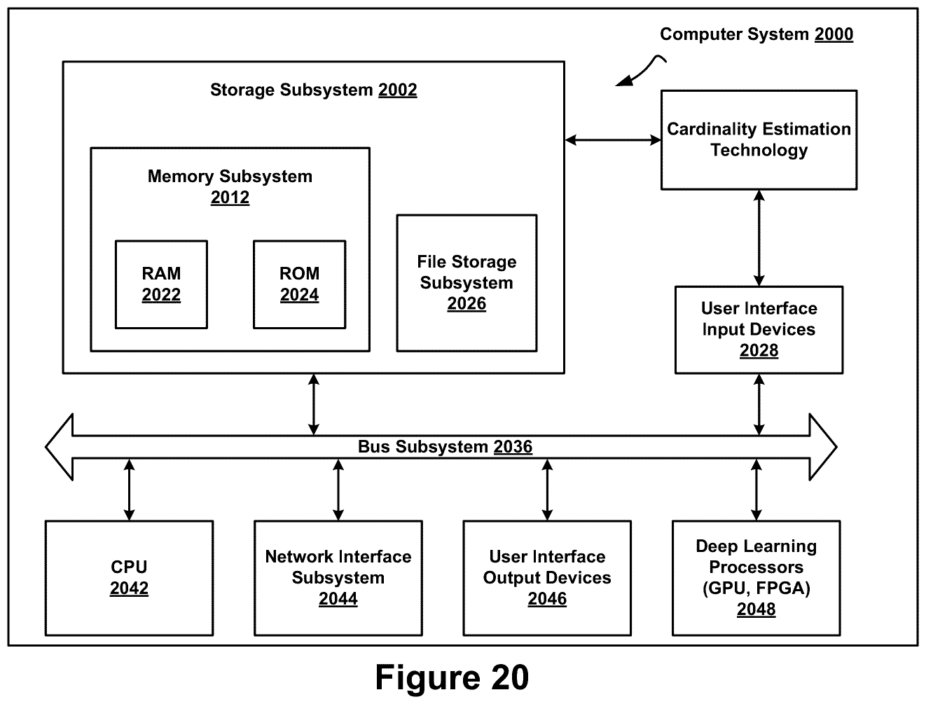

FIG. 20 shows an example computer system 2000 that can be used to implement the technology disclosed to estimate the cardinality of multi-join queries across relations in a database. Computer system 2000 includes at least one central processing unit (CPU) 2042 that communicates with a number of peripheral devices via bus subsystem 2026. These peripheral devices can include a storage subsystem 2002 including, for example, memory devices and a file storage subsystem 2026, user interface input devices 2028, user interface output devices 2046, and a network interface subsystem 2044. The input and output devices allow user interaction with computer system 2000. Network interface subsystem 2044 provides an interface to outside networks, including an interface to corresponding interface devices in other computer systems.

In one implementation, the technology disclosed is communicably linked to the storage subsystem 2002 and the user interface input devices 2028.

User interface input devices 2028 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2000.

User interface output devices 2046 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2000 to the user or to another machine or computer system.

Storage subsystem 2002 stores programming and data constructs that provide the functionality of some or all of the modules and methods described herein. These software modules are generally executed by processors 2048.

Processors 2048 can be graphics processing units (GPUs), field-programmable gate arrays (FPGAs), application-specific integrated circuits (ASICs), and/or coarse-grained reconfigurable architectures (CGRAs). Processors 2048 can be hosted by a deep learning cloud platform such as Google Cloud Platform™, Xilinx™, and Cirrascale™. Examples of processors 2048 include Google's Tensor Processing Unit (TPU)™, rackmount solutions like GX4 Rackmount Series™, GX20 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 2012 used in the storage subsystem 2002 can include a number of memories including a main random access memory (RAM) 2022 for storage of instructions and data during program execution and a read only memory (ROM) 2024 in which fixed instructions are stored. A file storage subsystem 2026 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2026 in the storage subsystem 2002, or in other machines accessible by the processor.

Bus subsystem 2036 provides a mechanism for letting the various components and subsystems of computer system 2000 communicate with each other as intended. Although bus subsystem 2036 is shown schematically as a single bus, alternative implementations of the bus subsystem can use multiple busses.

Computer system 2000 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 2000 depicted in FIG. 20 is intended only as a specific example for purposes of illustrating the preferred implementations of the present technology disclosed. Many other configurations of computer system 2000 are possible having more or less components than the computer system depicted in FIG. 20.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 20 is a schematic of an exemplary computing node. Computing node 2000 is only one example of a suitable computing node and is not intended to suggest any limitation as to the scope of use or functionality of embodiments described herein. Regardless, computing node 2000 is capable of being implemented and/or performing any of the functionality set forth hereinabove.

In computing node 2000 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 20, computer system/server in computing node 2000 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

1. A computer-implemented method of cardinality estimation of a multi-join query over relations in a database, wherein joins in the multi-join query connect joined attributes across the relations, including:
determining, for joined attributes of a particular relation with a particular relation stream (or tuple stream), sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream (or tuple stream), and combining the determined bin indices for the joined attributes to obtain a combined determined bin index for the particular tuple in the particular relation stream (or tuple stream);
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream (or tuple stream); and
at inference, combining the relation sketches created for the relations to estimate a cardinality of the multi-join query.
   2. The computer-implemented method of clause 1, further including:
initializing sign functions that produce sign values for the joined attributes and initializing bin functions that produce bin indices for the joined attributes connected by the joins.
   3. The computer-implemented method of clause 1, further including:
initializing corresponding zero counter vectors for the relations comprising joined attributes connected by the joins.
   4. The computer-implemented method of clause 3, wherein, in a logical space, the corresponding zero counter vectors are one-hot vectors that are on at the determined bin indices.
   5. The computer-implemented method of clause 3, wherein, in a physical space, the corresponding zero counter vectors have only the determined sign values at the determined bin indices.
   6. The computer-implemented method of clause 1, wherein the combining the determined sign values for the joined attributes further including, applying circular convolution to corresponding determined sign values to obtain the combined determined sign value that is stored at the bin index specified by the combined determined bin index.
   7. The computer-implemented method of clause 6, wherein the applying the circular convolution further includes summing values identified by corresponding determined bin indices for the joined attributes as a sum, followed by taking a modulo of the sum with a sketch length of the tuple sketch.
   8. The computer-implemented method of clause 6, wherein the circular convolution retains the non-zero value character of relation sketch of the relation stream at the bin index specified by the combined determined bin index by including at the bin index a product of non-zero entries at the determined bin indices encoded in the corresponding tuple sketches.
   9. The computer-implemented method of clause 1, further including multiplying the combined determined sign value of the particular tuple sketch by a change of frequency, followed by adding a result of the multiplying to the relation sketch for the particular relation at the bin index specified by the combined determined bin index.
   10. The computer-implemented method of clause 9, further including creating the relation sketch for the particular relation based on a result of the adding over the particular relation stream.
   11. The computer-implemented method of clause 1, wherein the sign functions for the joins are hash functions.
   12. The computer-implemented method of clause 1, wherein the bin functions for the joined attributes are hash functions.
   13. The computer-implemented method of clause 11, wherein the sign functions for the joins are sampled from a family of 4-wise independent hash functions.
   14. The computer-implemented method of clause 12, wherein the bin functions for the joined attributes connected by the joins are sampled from a family of 2-wise independent hash functions.
   15. The computer-implemented method of clause 1, wherein the combining the determined sign values to obtain the combined determined sign value for the particular tuple further includes multiplying together, the determined sign values.
   16. The computer-implemented method of clause 1, wherein the combining the relation sketches to estimate the cardinality of the multi-join query, further including:
selecting at least one joined attribute in the multi-join query over relations in the database as a root attribute in a graph representing the joined attributes in the multi-join query;
traversing, one by one, from leaf attributes of the graph towards the root attribute, (1) calculating Hadamard product between relation sketches when the corresponding relations are siblings of each other in the graph wherein all sibling nodes have a same parent node in the graph representing joined attributes in the multi-join query, (2) calculating cross-correlation between relation sketches of at least two relations having joined attributes such that two joined attributes are in a parent-child relationship in the graph representing joined attributes in the multi-join query; and
calculating a dot product between relation sketches of at least two relations having joined attributes such that at least one of the two joined attributes is a root node in the graph representing joined attributes in the multi-join query wherein the calculated dot product represents the estimate of the cardinality of the multi-join query.
   17. The computer-implemented method of clause 16, wherein the calculating cross-correlation further including applying a Fast Fourier Transform (FFT) to calculate the cross-correlation between relation sketches of the two joined attributes that are joined in a parent-child relationship in the graph representing joined attributes in the multi-join query.
   18. A non-transitory computer readable storage medium impressed with computer program instructions to estimate cardinality of a multi-join query over relations in a database, wherein joins in the multi-join query connect joined attributes across the relations, the instructions, when executed on a processor, implement a method, comprising:
determining, for joined attributes of a particular relation with a particular relation stream (or tuple stream), sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream (or tuple stream), and combining the determined bin indices for the joined attributes to obtain a combined determined bin index for the particular tuple in the particular relation stream (or tuple stream);
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream (or tuple stream); and
at inference, combining the relation sketches created for the relations to estimate a cardinality of the multi-join query.
   19. The non-transitory computer readable storage medium of clause 18, implementing the method further comprising:
initializing sign functions that produce sign values for the joined attributes and initializing bin functions that produce bin indices for the joined attributes connected by the joins.
   20. The non-transitory computer readable storage medium of clause 18, implementing the method further comprising:
initializing corresponding zero counter vectors for the relations comprising joined attributes connected by the joins.
   21. The non-transitory computer readable storage medium of clause 20, wherein, in a logical space, the corresponding zero counter vectors are one-hot vectors that are on at the determined bin indices.
   22. The non-transitory computer readable storage medium of clause 20, wherein, in a physical space, the corresponding zero counter vectors have only the determined sign values at the determined bin indices.
   23. The non-transitory computer readable storage medium of clause 18, wherein the combining the determined sign values for the joined attributes implementing the method further comprising, applying circular convolution to corresponding determined sign values to obtain the combined determined sign value that is stored at the bin index specified by the combined determined bin index.
   24. The non-transitory computer readable storage medium of clause 23, wherein the applying the circular convolution further includes summing values identified by corresponding determined bin indices for the joined attributes as a sum, followed by taking a modulo of the sum with a sketch length of the tuple sketch.
   25. The non-transitory computer readable storage medium of clause 23, wherein the circular convolution retains the non-zero value character of relation sketch of the relation stream at the bin index specified by the combined determined bin index by including at the bin index a product of non-zero entries at the determined bin indices encoded in the corresponding tuple sketches.
   26. The non-transitory computer readable storage medium of clause 18, further including multiplying the combined determined sign value of the particular tuple sketch by a change of frequency, followed by adding a result of the multiplying to the relation sketch for the particular relation at the bin index specified by the combined determined bin index.
   27. The non-transitory computer readable storage medium of clause 26, implementing the method further comprising:
creating the relation sketch for the particular relation based on a result of the adding over the particular relation stream.
   28. The non-transitory computer readable storage medium of clause 18, wherein the sign functions for the joins are hash functions.
   29. The non-transitory computer readable storage medium of clause 18, wherein the bin functions for the joined attributes are hash functions.
   30. The non-transitory computer readable storage medium of clause 28, wherein the sign functions for the joins are sampled from a family of 4-wise independent hash functions.
   31. The non-transitory computer readable storage medium of clause 29, wherein the bin functions for the joined attributes connected by the joins are sampled from a family of 2-wise independent hash functions.
   32. The non-transitory computer readable storage medium of clause 18, wherein the combining the determined sign values to obtain the combined determined sign value for the particular tuple further includes multiplying together, the determined sign values.
   33. The non-transitory computer readable storage medium of clause 18, wherein the combining the relation sketches to estimate the cardinality of the multi-join query, implementing the method further comprising:
selecting at least one joined attribute in the multi-join query over relations in the database as a root attribute in a graph representing the joined attributes in the multi-join query;
traversing, one by one, from leaf attributes of the graph towards the root attribute, (1) calculating Hadamard product between relation sketches when the corresponding relations are siblings of each other in the graph wherein all sibling nodes have a same parent node in the graph representing joined attributes in the multi-join query, (2) calculating cross-correlation between relation sketches of at least two relations having joined attributes such that two joined attributes are in a parent-child relationship in the graph representing joined attributes in the multi-join query; and
calculating a dot product between relation sketches of at least two relations having joined attributes such that at least one of the two joined attributes is a root node in the graph representing joined attributes in the multi-join query wherein the calculated dot product represents the estimate of the cardinality of the multi-join query.
   34. The non-transitory computer readable storage medium of clause 33, wherein the calculating cross-correlation, implementing the method further comprising:
applying a Fast Fourier Transform (FFT) to calculate the cross-correlation between relation sketches of the two joined attributes that are joined in a parent-child relationship in the graph representing joined attributes in the multi-join query.
   35. A system including one or more processors coupled to memory, the memory loaded with computer instructions to estimate cardinality of a multi-join query over relations in a database, wherein joins in the multi-join query connect joined attributes across the relations, the instructions, when executed on the processors, implement, at a server node, actions comprising:
determining, for joined attributes of a particular relation with a particular relation stream (or tuple stream), sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream (or tuple stream), and combining the determined bin indices for the joined attributes to obtain a combined determined bin index for the particular tuple in the particular relation stream (or tuple stream);
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream (or tuple stream); and
at inference, combining the relation sketches created for the relations to estimate a cardinality of the multi-join query.
   36. The system of clause 35, further implementing actions comprising:
initializing sign functions that produce sign values for the joined attributes and initializing bin functions that produce bin indices for the joined attributes connected by the joins.
   37. The system of clause 35, further implementing actions comprising:
initializing corresponding zero counter vectors for the relations comprising joined attributes connected by the joins.
   38. The system of clause 37, wherein, in a logical space, the corresponding zero counter vectors are one-hot vectors that are on at the determined bin indices.
   39. The system of clause 37, wherein, in a physical space, the corresponding zero counter vectors have only the determined sign values at the determined bin indices.
   40. The system of clause 35, wherein the combining the determined sign values for the joined attributes further implementing actions comprising:
applying circular convolution to corresponding determined sign values to obtain the combined determined sign value that is stored at the bin index specified by the combined determined bin index.
   41. The system of clause 40, wherein the applying the circular convolution further implementing actions comprising:
summing values identified by corresponding determined bin indices for the joined attributes as a sum, followed by taking a modulo of the sum with a sketch length of the tuple sketch.
   42. The system of clause 40, wherein the circular convolution retains the non-zero value character of relation sketch of the relation stream at the bin index specified by the combined determined bin index by including at the bin index a product of non-zero entries at the determined bin indices encoded in the corresponding tuple sketches.
   43. The system of clause 35, further implementing actions comprising:
multiplying the combined determined sign value of the particular tuple sketch by a change of frequency, followed by adding a result of the multiplying to the relation sketch for the particular relation at the bin index specified by the combined determined bin index.
   44. The system of clause 43, further implementing actions comprising:
creating the relation sketch for the particular relation based on a result of the adding over the particular relation stream.
   45. The system of clause 35, wherein the sign functions for the joins are hash functions.
   46. The system of clause 35, wherein the bin functions for the joined attributes are hash functions.
   47. The system of clause 45, wherein the sign functions for the joins are sampled from a family of 4-wise independent hash functions.
   48. The system of clause 46, wherein the bin functions for the joined attributes connected by the joins are sampled from a family of 2-wise independent hash functions.
   49. The system of clause 35, wherein the combining the determined sign values to obtain the combined determined sign value for the particular tuple further includes multiplying together, the determined sign values.
   50. The system of clause 35, wherein the combining the relation sketches to estimate the cardinality of the multi-join query, further implementing actions comprising:
selecting at least one joined attribute in the multi-join query over relations in the database as a root attribute in a graph representing the joined attributes in the multi-join query;
traversing, one by one, from leaf attributes of the graph towards the root attribute, (1) calculating Hadamard product between relation sketches when the corresponding relations are siblings of each other in the graph wherein all sibling nodes have a same parent node in the graph representing joined attributes in the multi-join query, (2) calculating cross-correlation between relation sketches of at least two relations having joined attributes such that two joined attributes are in a parent-child relationship in the graph representing joined attributes in the multi-join query; and
calculating a dot product between relation sketches of at least two relations having joined attributes such that at least one of the two joined attributes is a root node in the graph representing joined attributes in the multi-join query wherein the calculated dot product represents the estimate of the cardinality of the multi-join query.
   51. The system of clause 50, wherein the calculating cross-correlation further implementing actions comprising:
applying a Fast Fourier Transform (FFT) to calculate the cross-correlation between relation sketches of the two joined attributes that are joined in a parent-child relationship in the graph representing joined attributes in the multi-join query.
   52. A computer-implemented method of cardinality estimation of a multi-join query over relations in a database, wherein joins in the multi-join query connect joined attributes across the relations, including:
for the joins, initializing sign functions that produce sign values, for sets of the joined attributes connected by the joins, initializing bin functions that produce bin indices, and for the relations, initializing zero counter vectors;
creating joined attribute sketches for joined attributes of a particular relation with a particular tuple stream based on determining sign values and bin indices for the joined attributes of the particular relation using corresponding sign functions and bin functions initialized for the joined attributes of the particular relation;
encoding the determined sign values and the determined bin indices in corresponding zero counter vectors initialized for the joined attributes of the particular relation;
accumulating a sign for the particular tuple stream based on the determined sign values encoded in the corresponding zero counter vectors, and accumulating a bin for the particular tuple stream based on the determined bin indices encoded in the corresponding zero counter vectors;
creating a tuple sketch for the particular tuple stream based on the accumulated sign and the accumulated bin, wherein the tuple sketch is an information-preserving combination of the joined attribute sketches, and retains a non-zero value character of the joined attribute sketches at a bin index specified by the accumulated bin;
creating tuple sketches for tuple streams of each of the relations, and combining the tuple sketches on a relation-basis to create relation sketches for the relations; and
at inference, combining the relation sketches created for the relations to estimate a cardinality of the multi-join query.
   53. The computer-implemented method of clause 52, wherein a circular convolution executes the information-preserving combination of the joined attribute sketches, and produces the accumulated sign and the accumulated bin of the particular tuple stream.
   54. The computer-implemented method of clause 53, wherein the circular convolution sums a bin index of a non-zero entry encoded in the corresponding zero counter vectors, followed by taking a modulo of a sketch length of the corresponding zero counter vectors.
   55. The computer-implemented method of clause 54, wherein the circular convolution retains the non-zero value character of the joined attribute sketches at the bin index specified by the accumulated bin by including at the bin index a product of non-zero entries at the non-zero ones of the determined bin indices encoded in the corresponding zero counter vectors.
   56. The computer-implemented method of clause 52, further including multiplying the accumulated sign of the particular tuple stream by a change of frequency, followed by adding a result of the multiplying to a non-zero value at the bin index specified by the accumulated bin.
   57. The computer-implemented method of clause 56, further including creating the tuple sketch based on a result of the adding.
   58. The computer-implemented method of clause 52, wherein the sign functions for the joins are hash functions.
   59. The computer-implemented method of clause 52, wherein the bin functions for the sets of the joined attributes are hash functions.
   60. The computer-implemented method of clause 58, wherein the sign functions for the joins are sampled from a family of 4-wise independent hash functions.
   61. The computer-implemented method of clause 59, wherein the bin functions for the sets of the joined attributes connected by the joins are sampled from a family of 2-wise independent hash functions.
   62. The computer-implemented method of clause 52, wherein the determined sign values are accumulated by multiplying them together.
   63. The computer-implemented method of clause 52, wherein, in a logical space, the corresponding zero counter vectors are one-hot vectors that are on at the determined bin indices.
   64. The computer-implemented method of clause 52, wherein, in a physical space, the corresponding zero counter vectors have only the determined sign values at the determined bin indices.
   65. The computer-implemented method of clause 52, further including combining the relation sketches created for the relations to estimate the cardinality of the multi-join query using Hadamard product.
   66. The computer-implemented method of clause 52, further including combining the relation sketches created for the relations to estimate the cardinality of the multi-join query using a fast Fourier transform (FFT)-based circular cross-correlation.

What we claim is:

1. A computer-implemented method of cardinality estimation of a multi-join query over relations in a database, wherein joins in the multi-join query connect joined attributes across the relations, including:
determining, for joined attributes of a particular relation with a particular relation stream, sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream, and combining the determined bin indices for the joined attributes to obtain a combined determined bin index for the particular tuple in the particular relation stream;
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream; and
at inference, combining the relation sketches created for the relations to estimate a cardinality of the multi-join query.

2. The computer-implemented method of claim 1, further including:
initializing sign functions that produce sign values for the joined attributes and initializing bin functions that produce bin indices for the joined attributes connected by the joins.

3. The computer-implemented method of claim 1, further including:
initializing corresponding zero counter vectors for the relations comprising joined attributes connected by the joins.

4. The computer-implemented method of claim 3, wherein, in a logical space, the corresponding zero counter vectors are one-hot vectors that are on at the determined bin indices.

5. The computer-implemented method of claim 3, wherein, in a physical space, the corresponding zero counter vectors have only the determined sign values at the determined bin indices.

6. The computer-implemented method of claim 1, wherein the combining the determined sign values for the joined attributes further including, applying circular convolution to corresponding determined sign values to obtain the combined determined sign value that is stored at the bin index specified by the combined determined bin index.

7. The computer-implemented method of claim 6, wherein the applying the circular convolution further includes summing values identified by corresponding determined bin indices for the joined attributes as a sum, followed by taking a modulo of the sum with a sketch length of the tuple sketch.

8. The computer-implemented method of claim 6, wherein the circular convolution retains the non-zero value character of relation sketch of the relation stream at the bin index specified by the combined determined bin index by including at the bin index a product of non-zero entries at the determined bin indices encoded in the corresponding tuple sketches.

9. The computer-implemented method of claim 1, further including multiplying the combined determined sign value of the particular tuple sketch by a change of frequency, followed by adding a result of the multiplying to the relation sketch for the particular relation at the bin index specified by the combined determined bin index.

10. The computer-implemented method of claim 9, further including creating the relation sketch for the particular relation based on a result of the adding over the particular relation stream.

11. The computer-implemented method of claim 1, wherein the sign functions for the joins are hash functions.

12. The computer-implemented method of claim 1, wherein the bin functions for the joined attributes are hash functions.

13. The computer-implemented method of claim 11, wherein the sign functions for the joins are sampled from a family of 4-wise independent hash functions.

14. The computer-implemented method of claim 12, wherein the bin functions for the joined attributes connected by the joins are sampled from a family of 2-wise independent hash functions.

15. The computer-implemented method of claim 1, wherein the combining the determined sign values to obtain the combined determined sign value for the particular tuple further includes multiplying together, the determined sign values.

16. The computer-implemented method of claim 1, wherein the combining the relation sketches to estimate the cardinality of the multi-join query, further including:
selecting at least one joined attribute in the multi-join query over relations in the database as a root attribute in a graph representing the joined attributes in the multi-join query;
traversing, one by one, from leaf attributes of the graph towards the root attribute, (1) calculating Hadamard product between relation sketches when the corresponding relations are siblings of each other in the graph wherein all sibling nodes have a same parent node in the graph representing joined attributes in the multi-join query, (2) calculating cross-correlation between relation sketches of at least two relations having joined attributes such that two joined attributes are in a parent-child relationship in the graph representing joined attributes in the multi-join query; and
calculating a dot product between relation sketches of at least two relations having joined attributes such that at least one of the two joined attributes is a root node in the graph representing joined attributes in the multi-join query wherein the calculated dot product represents the estimate of the cardinality of the multi-join query.

17. The computer-implemented method of claim 16, wherein the calculating cross-correlation further including applying a Fast Fourier Transform (FFT) to calculate the cross-correlation between relation sketches of the two joined attributes that are joined in a parent-child relationship in the graph representing joined attributes in the multi-join query.

18. A non-transitory computer readable storage medium impressed with computer program instructions to estimate cardinality of a multi-join query over relations in a database, wherein joins in the multi-join query connect joined attributes across the relations, the instructions, when executed on a processor, implement a method, comprising:
determining, for joined attributes of a particular relation with a particular relation stream, sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream, and combining the determined bin indices for the joined attributes to obtain a combined determined bin index for the particular tuple in the particular relation stream;
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream; and
at inference, combining the relation sketches created for the relations to estimate a cardinality of the multi-join query.

19. A system including one or more processors coupled to memory, the memory loaded with computer instructions to estimate cardinality of a multi-join query over relations in a database, wherein joins in the multi-join query connect joined attributes across the relations, the instructions, when executed on the processors, implement, at a server node, actions comprising:
determining, for joined attributes of a particular relation with a particular relation stream, sign values and bin indices for the joined attributes of the particular relation using corresponding sign functions and bin functions initialized for the joined attributes of the particular relation;
combining the determined sign values for the joined attributes to obtain a combined determined sign value for a particular tuple in the particular relation stream, and combining the determined bin indices for the joined attributes to obtain a combined determined bin index for the particular tuple in the particular relation stream;
creating a tuple sketch for the particular tuple in the particular relation stream based on the combined determined sign value and the combined determined bin index, wherein the tuple sketch is a combination of the determined sign values and the determined bin indices for the joined attributes, and retains a non-zero value character at a bin index specified by the determined bin index;
creating relation sketches for corresponding relations wherein a relation sketch for the particular relation is created by accumulating, on a relation basis, tuple sketches of corresponding tuples in the particular relation stream; and
at inference, combining the relation sketches created for the relations to estimate a cardinality of the multi-join query.

20. The system of claim 19, wherein the combining the relation sketches to estimate the cardinality of the multi-join query, further implementing actions comprising:
selecting at least one joined attribute in the multi-join query over relations in the database as a root attribute in a graph representing the joined attributes in the multi-join query;
traversing, one by one, from leaf attributes of the graph towards the root attribute, (1) calculating Hadamard product between relation sketches when the corresponding relations are siblings of each other in the graph wherein all sibling nodes have a same parent node in the graph representing joined attributes in the multi-join query, (2) calculating cross-correlation between relation sketches of at least two relations having joined attributes such that two joined attributes are in a parent-child relationship in the graph representing joined attributes in the multi-join query; and
calculating a dot product between relation sketches of at least two relations having joined attributes such that at least one of the two joined attributes is a root node in the graph representing joined attributes in the multi-join query wherein the calculated dot product represents the estimate of the cardinality of the multi-join query.
